(19) United States
(12) Patent Application Publication
(10) Pub. No.: US 2025/0251839 A1
(43) Pub. Date: Aug. 7, 2025

(54) ELECTROMAGNETIC INDUCTION PEN, INTEGRATED CIRCUIT, AND POSITION DETECTING DEVICE

(71) Applicant: Wacom Co., Ltd., Saitama (JP)

(72) Inventors: Akira ITO, Saitama (JP); Yoshihisa SUGIYAMA, Saitama (JP); Hiroshi MIZUHASHI, Saitama (JP); Fumitaka GOTO, Saitama (JP); Joo Hoon LEE, Saitama (JP)

(21) Appl. No.: 19/187,715

(22) Filed: Apr. 23, 2025

Related U.S. Application Data
(63) Continuation of application No. PCT/JP2023/036639, filed on Oct. 6, 2023.

(30) Foreign Application Priority Data
Oct. 28, 2022 (JP) 2022-173666

(51) Int. Cl. G06F 3/046; G06F 3/044

(52) U.S. Cl. CPC G06F 3/046; G06F 3/0442; G06F 2203/04106

(57) ABSTRACT

An electromagnetic induction pen includes a first resonance circuit including a coil and a capacitor as well as a variable capacitance capacitor connected to the first resonance circuit. The variable capacitance capacitor is a changing element that changes a resonance frequency of a second resonance circuit that includes the variable capacitance capacitor and the first resonance circuit based on a behavior of a user. The electromagnetic induction pen further includes a toggle circuit that switches between sending out a reference alternating magnetic field by using the first resonance circuit and sending out a modulated alternating magnetic field by using the second resonance circuit.

### BACKGROUND

### Technical Field

The present disclosure relates to an electromagnetic induction pen, an integrated circuit, and a position detecting device.

### Description of the Related Art

An electromagnetic induction pen is known which is configured to be able to switch between a first resonance circuit formed by connecting an inductance element and a capacitance element in series with each other and a second resonance circuit formed by adding a variable capacitance element to the first resonance circuit, and is configured to send out an alternating magnetic field from any one of the resonance circuits. The variable capacitance element is configured to change in capacitance according to a pen pressure (pressure applied to a pen tip) of the electromagnetic induction pen. The variable capacitance element is connected in parallel with the capacitance element constituting the first resonance circuit. In the following, the alternating magnetic field sent out by the electromagnetic induction pen by using the first resonance circuit will be referred to as a “reference alternating magnetic field,” and the alternating magnetic field sent out by the electromagnetic induction pen by using the second resonance circuit will be referred to as a “modulated alternating magnetic field.”

A position detecting device that detects the position of the electromagnetic induction pen of this kind is configured to store the frequency of the reference alternating magnetic field sent out from the electromagnetic induction pen operating by using the first resonance circuit as a reference frequency and detect the pen pressure on the basis of a difference between the frequency of the modulated alternating magnetic field sent out from the electromagnetic induction pen operating by using the second resonance circuit and the reference frequency stored in advance. This makes it possible to detect the pen pressure of the electromagnetic induction pen with high accuracy even when the resonance frequency of the first resonance circuit (=Reference Frequency) has changed due to the presence of metal in the vicinity of the electromagnetic induction pen or the like.

Patent Document 1 discloses an example of the electromagnetic induction pen of this kind and the position detecting device. The electromagnetic induction pen (position indicator) described in the document includes a normally-on-type junction field effect transistor (JFET: Junction Field Effect Transistor) connected in series with the variable capacitance element described above, and is configured such that the J FET is off when an alternating magnetic field from the position detecting device continues for a certain time or more. The position detecting device of Patent Document 1 can thereby make the electromagnetic induction pen send out the reference alternating magnetic field by continuing sending out the alternating magnetic field over a predetermined time or more.

In addition, Patent Document 1 also discloses providing a switch circuit for short-circuiting the first resonance circuit, and enabling digital data to be transmitted through on-off modulation from the electromagnetic induction pen to the position detecting device by controlling the switch circuit to an on state when transmitting a bit “0” and controlling the switch circuit to an off state when transmitting a bit “1.”

### PRIOR ART DOCUMENT

### Patent Document

Patent Document 1: PCT Patent Publication No. WO2016/056299

### BRIEF SUMMARY

### Technical Problems

However, according to the configuration described in Patent Document 1, the position detecting device needs to continue sending out the alternating magnetic field over a predetermined time or more in order to make the electromagnetic induction pen send out the reference alternating magnetic field. The reference frequency may change in a shorter time than the predetermined time. In addition, sending out of the alternating magnetic field over a long time cannot be performed frequently. Thus, with the configuration described in Patent Document 1, the reference frequency stored by the position detecting device may deviate from the value of an actual reference frequency in a timing of receiving the modulated alternating magnetic field, and as a result, the accuracy of detection of the pen pressure may be decreased. The same is true for a case where the capacitance of the variable capacitance element is changed according to a value indicating behavior of a user other than the pen pressure (value indicating a casing gripping pressure or the like), and the accuracy of detection of the value may be decreased.

Accordingly, embodiments of the present disclosure provide an electromagnetic induction pen and an integrated circuit that can improve the accuracy of detection of a value indicating the behavior of a user more than conventional.

In addition, according to the configuration of Patent Document 1, even when no pressure is applied to the pen tip, the above-described difference (difference between the frequency of the modulated alternating magnetic field and the reference frequency) may not be a predetermined value indicating that no pressure is applied to the pen tip (the predetermined value is normally zero, and will hereinafter be referred to as a “hover indication value”). This is attributable to constant slight oscillation of the frequency of the alternating magnetic field sent out from the electromagnetic induction pen due to the self-capacitance of the above-described J FET, an external factor, and the like. However, an improvement is needed because processing for essentially determining whether or not a pressure is applied to the pen tip needs to be implemented in a drawing application.

Accordingly, embodiments of the present disclosure provide a position detecting device that can use the difference between the frequency of the reference alternating magnetic field and the frequency of the modulated alternating magnetic field as the hover indication value when no pressure is applied to the pen tip.

In addition, according to the configuration of Patent Document 1, the electromagnetic induction pen is in a state of not sending out any alternating magnetic field when the switch circuit described above is on in order to transmit a bit “0.” An improvement is needed because this state is not desirable.

Accordingly, embodiments of the present disclosure provide an electromagnetic induction pen and a position detecting device that can maintain a state of sending out an alternating magnetic field from the electromagnetic induction pen even when digital data is transmitted.

In addition, according to the configuration of Patent Document 1, in an embodiment in which the electromagnetic induction pen transmits an identification signal ID (FIG. 11), the position detecting device receives an alternating magnetic field from the electromagnetic induction pen (including an alternating magnetic field for detecting the pen pressure and an alternating magnetic field for receiving the identification signal ID) during sending out of a burst signal. However, with this configuration, the burst signal is superimposed on the alternating magnetic field from the electromagnetic induction pen. The detection of the pen pressure and the reception of the identification signal ID may therefore fail.

Accordingly, embodiments of the present disclosure provide an electromagnetic induction pen that can prevent the position detecting device from failing in detecting an analog operation amount transmitted by the electromagnetic induction pen and receiving the digital data.

### Technical Solution

An electromagnetic induction pen according to a first aspect of the present disclosure is an electromagnetic induction pen including a first resonance circuit including an inductance element and a capacitance element, a changing element connected to the first resonance circuit, wherein the changing element, in operation, changes a resonance frequency of a second resonance circuit including the changing element and the first resonance circuit based on a behavior of a user, and a toggle circuit that, in operation, switches between sending out of a reference alternating magnetic field by using the first resonance circuit and sending out of a modulated alternating magnetic field by using the second resonance circuit.

An integrated circuit according to a second aspect of the present disclosure is an integrated circuit for a position detecting device, the integrated circuit includes a processor, and a memory storing instructions that, when executed by the processor, cause the integrated circuit to: receive a received alternating magnetic field that is a reference alternating magnetic field generated by using a first resonance circuit or a modulated alternating magnetic field generated by using a second resonance circuit from an electromagnetic induction pen including the first resonance circuit, the second resonance circuit, and a changing element, wherein the first resonance circuit includes an inductance element and a capacitance element, wherein the changing element is connected to the first resonance circuit, wherein the changing element, in operation, changes a resonance frequency of the second resonance circuit based on a behavior of a user, and wherein the second resonance circuit includes the changing element and the first resonance circuit, determine whether the received alternating magnetic field is the reference alternating magnetic field or the modulated alternating magnetic field, and output a digital value corresponding to an analog quantity indicated by the modulated alternating magnetic field in response to the received alternating magnetic field being determined to be the reference alternating magnetic field.

A position detecting device according to a third aspect of the present disclosure is a position detecting device that includes a processor, and a memory storing instructions that, when executed by the processor, cause the position detecting device to: receive each of a reference alternating magnetic field generated by using a first resonance circuit and a modulated alternating magnetic field generated by using a second resonance circuit from an electromagnetic induction pen including the first resonance circuit, the second resonance circuit, and a changing element, wherein the first resonance circuit includes an inductance element and a capacitance element, wherein the changing element is connected to the first resonance circuit, wherein the changing element, in operation, changes a resonance frequency of the second resonance circuit based on a behavior of a user, wherein the second resonance circuit includes the changing element and the first resonance circuit, obtain a first output based on the reference alternating magnetic field, obtain a second output based on the modulated alternating magnetic field, obtain a third output by adding or subtracting a predetermined offset amount to or from a difference between the first output and the second output, and convert the third output into a digital value by a predetermined conversion rule.

An electromagnetic induction pen according to a fourth aspect of the present disclosure is an electromagnetic induction pen including a first resonance circuit including an inductance element and a capacitance element, a changing element connected to the first resonance circuit, wherein the changing element, in operation, changes a resonance frequency of a second resonance circuit including the changing element and the first resonance circuit based on a behavior of a user, and a processing circuit that, in operation, switches between sending out a reference alternating magnetic field by using the first resonance circuit and sending out a modulated alternating magnetic field by using the second resonance circuit based on a bit value to be transmitted to a position detecting device.

A position detecting device according to a fourth aspect of the present disclosure is a position detecting device that includes a processor, and a memory storing instructions that, when executed by the processor, cause the position detecting device to: receive a received alternating magnetic field that is a reference alternating magnetic field generated by using a first resonance circuit or a modulated alternating magnetic field generated by using a second resonance circuit from an electromagnetic induction pen including the first resonance circuit, the second resonance circuit, and a changing element, wherein the first resonance circuit includes an inductance element and a capacitance element, wherein the changing element is connected to the first resonance circuit, wherein the changing element, in operation, changes a resonance frequency of the second resonance circuit based on a behavior of a user, wherein the second resonance circuit includes the changing element and the first resonance circuit, determine whether the received alternating magnetic field is the reference alternating magnetic field or the modulated alternating magnetic field, and obtain a bit value transmitted by the electromagnetic induction pen based on a result of determining whether the received alternating magnetic field is the reference alternating magnetic field or the modulated alternating magnetic field.

An electromagnetic induction pen according to a fifth aspect of the present disclosure is an electromagnetic induction pen that includes a processor, and a memory storing instructions that, when executed by the processor, cause the electromagnetic induction pen to: perform transmission of digital data by digital modulation and transmission of an analog operation amount by analog modulation in a period in which a sensor controller is not sending out an alternating magnetic field.

### Advantageous Effect

According to the first and second aspects of the present disclosure, the reference alternating magnetic field can be sent out from the electromagnetic induction pen even when sending out of an alternating magnetic field is not performed from the position detecting device over a predetermined time or more. The accuracy of detection of a value indicating the behavior of a user can therefore be improved more than conventional.

According to the third aspect of the present disclosure, a predetermined offset amount is added to or subtracted from the difference between the first output obtained on the basis of the reference alternating magnetic field and the second output obtained on the basis of the modulated alternating magnetic field. The difference between the frequency of the reference alternating magnetic field and the frequency of the modulated alternating magnetic field can therefore be set as the hover indication value when no pressure is applied to the pen tip.

According to the fourth aspect of the present disclosure, a bit value can be transmitted by switching between sending out of the reference alternating magnetic field and sending out of the modulated alternating magnetic field. A state of sending out an alternating magnetic field from the electromagnetic induction pen can therefore be maintained even when digital data is transmitted.

According to the fifth aspect of the present disclosure, both the digital data and the analog operation amount are transmitted in a period in which the sensor controller is not sending out an alternating magnetic field. It is therefore possible to prevent the position detecting device from failing in detecting the analog operation amount transmitted by the electromagnetic induction pen and receiving the digital data.

### BRIEF DESCRIPTION OF THE SEVERAL VIEWS OF THE DRAWINGS

FIG. 1 is a diagram illustrating changes in a reference alternating magnetic field or a modulated alternating magnetic field in a case where metal is brought close to or separated from the panel surface of a position detecting device in a state in which a pen pressure is fixed.

FIG. 2 is a diagram illustrating a configuration of a position detection system 1 according to a first embodiment of the present disclosure.

FIG. 3 is a diagram of assistance in explaining operation of a sensor controller 31 and a processing circuit 23 according to the first embodiment of the present disclosure.

FIG. 4 is a diagram illustrating an internal configuration of the processing circuit 23 for implementing the operation described with reference to FIG. 3.

FIG. 5 is a diagram illustrating a detailed configuration of a detecting circuit 41 and a wait detecting circuit 42.

FIG. 6 is a diagram illustrating a result of simulation of an electromotive force PE, waveforms appearing at output nodes n1 and n2, a clock signal Pen_clk, and a wait detection signal det_wait.

FIG. 7 is a flowchart illustrating processing performed by the sensor controller 31 according to the first embodiment of the present disclosure.

FIG. 8 is a flowchart illustrating processing performed by the sensor controller 31 according to the first embodiment of the present disclosure.

FIG. 9 is a diagram illustrating a result of measurement of temporal changes in a modulated phase phCw, a reference phase phDh, a difference phCw-phDh, and a pen pressure value P obtained in the sensor controller 31 according to the first embodiment of the present disclosure.

FIG. 10 is a diagram illustrating a configuration of a position detection system 1 according to a second embodiment of the present disclosure.

FIG. 11 is a diagram of assistance in explaining operation of a sensor controller 31 and a processing circuit 23 according to the second embodiment of the present disclosure.

FIG. 12 is a diagram illustrating an internal configuration of the processing circuit 23 for implementing the operation described with reference to FIG. 11.

FIG. 13 is a diagram illustrating a detailed configuration of a detecting circuit 41, a wait detecting circuit 42, and a long burst detecting circuit 44.

FIG. 14 is a diagram illustrating a result of simulation of the waveforms of an electromotive force PE, output nodes n1 and n2, a clock signal Pen_clk, a wait detection signal det_wait, and a long burst detection signal det_Ib.

FIG. 15 is a diagram illustrating an internal configuration of a timing generating circuit 45.

FIG. 16 is a flowchart illustrating processing performed by the sensor controller 31 according to the second embodiment of the present disclosure.

FIG. 17 is a flowchart illustrating processing performed by the sensor controller 31 according to the second embodiment of the present disclosure.

FIG. 18 is a diagram illustrating details of digital data reception processing performed in step S37 in FIG. 16.

FIG. 19 is a diagram illustrating an internal configuration of an electromagnetic induction pen 2 of a position detection system 1 according to a third embodiment of the present disclosure.

FIG. 20 is a flowchart illustrating digital data reception processing performed by a sensor controller 31 according to the third embodiment of the present disclosure.

FIG. 21 is a diagram of assistance in explaining operation of a sensor controller 31 and a processing circuit 23 according to a fourth embodiment of the present disclosure.

FIG. 22 is a diagram of assistance in explaining operation of the sensor controller 31 and the processing circuit 23 according to the fourth embodiment of the present disclosure.

FIG. 23 is a diagram of assistance in explaining operation of the sensor controller 31 and the processing circuit 23 according to the fourth embodiment of the present disclosure.

FIG. 24 is a flowchart illustrating processing performed by the sensor controller 31 according to the fourth embodiment of the present disclosure.

FIG. 25 is a flowchart illustrating processing performed by the sensor controller 31 according to the fourth embodiment of the present disclosure.

FIG. 26 is a diagram illustrating a configuration of an electromagnetic induction pen 2 according to a fifth embodiment of the present disclosure.

FIG. 27A is a diagram illustrating a relation between values transmitted by the electromagnetic induction pen 2 according to the fifth embodiment of the present disclosure, the on/off states of switch elements 24 and 65 to 68, a combined capacitance Cc of capacitors incorporated in a resonance circuit among capacitors C, C_{sw}, and C₁ to C₄, and a resonance frequency f_{R} of the resonance circuit, and FIG. 27B is a diagram illustrating, on a straight line, values of the resonance frequency f_{R}, which correspond to respective transmission values.

### DETAILED DESCRIPTION

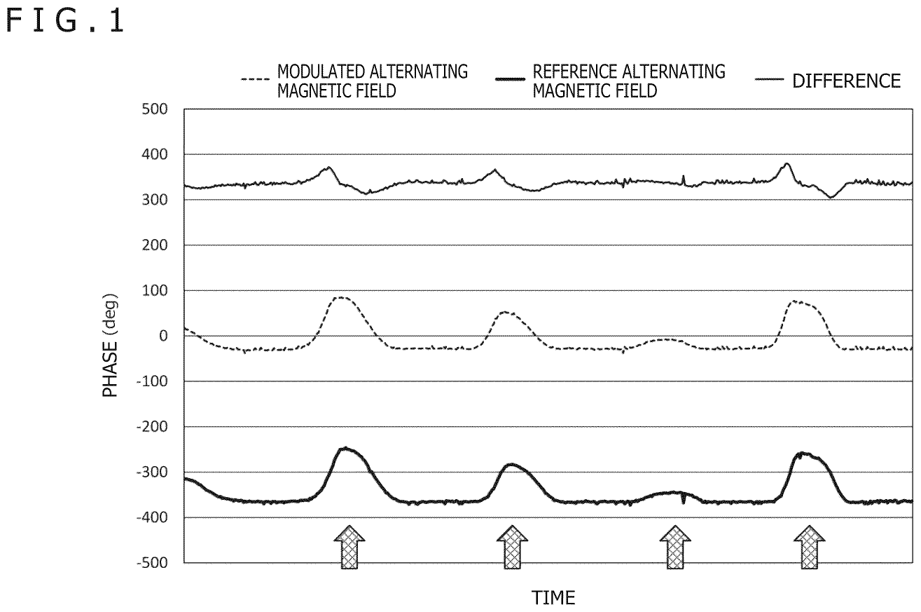

First, main objects of the present disclosure will be described again in detail. FIG. 1 is a diagram illustrating changes in a reference alternating magnetic field or a modulated alternating magnetic field in a case where metal is brought close to or separated from the panel surface of a position detecting device in a state in which a pen pressure is fixed. Incidentally, in the figure, an axis of ordinates indicates a phase. This is because the position detecting device is configured to detect changes in frequency by detecting the phase of a received signal. Details of this will be described later. In the following, the phase corresponding to the frequency of the reference alternating magnetic field will be referred to as a “reference phase,” and the phase corresponding to the frequency of the modulated alternating magnetic field will be referred to as a “modulated phase.”

In FIG. 1, time periods during which the metal is brought close to the panel surface are indicated by arrows (at four positions). As is understood from the result of the figure, both the reference phase and the modulated phase change greatly when the metal is brought close to the panel surface. Furthermore, the magnitudes of the changes in the reference phase and the modulated phase are not the same values, and therefore changes occur also in difference between these phases. Hence, even though the original pen pressure is fixed, the value of the pen pressure detected by the position detecting device is not fixed.

In addition, in the measurement result of FIG. 1, slight oscillations occur in the difference between the reference phase and the modulated phase even when the metal is not brought close. This is due to the self-capacitance of a switch for switching between a first resonance circuit and a second resonance circuit, noise coming from the outside, and the like. The oscillations of the difference mean that the value of the pen pressure detected by the position detecting device also oscillates.

Thus, the phase (frequency) of an alternating magnetic field sent out from an electromagnetic induction pen varies easily due to various reasons other than the pen pressure. Then, such variation occurs even during a very short time, and decreases the accuracy of detection of a value indicating the behavior of a user, including the pen pressure value. This also constitutes a factor in generating a pen pressure even though a pen tip is not in contact with the panel surface. One of objects of the present disclosure is to remedy these conditions. In the following, an embodiment of the present disclosure for solving such problems will be described in detail with reference to the accompanying drawings.

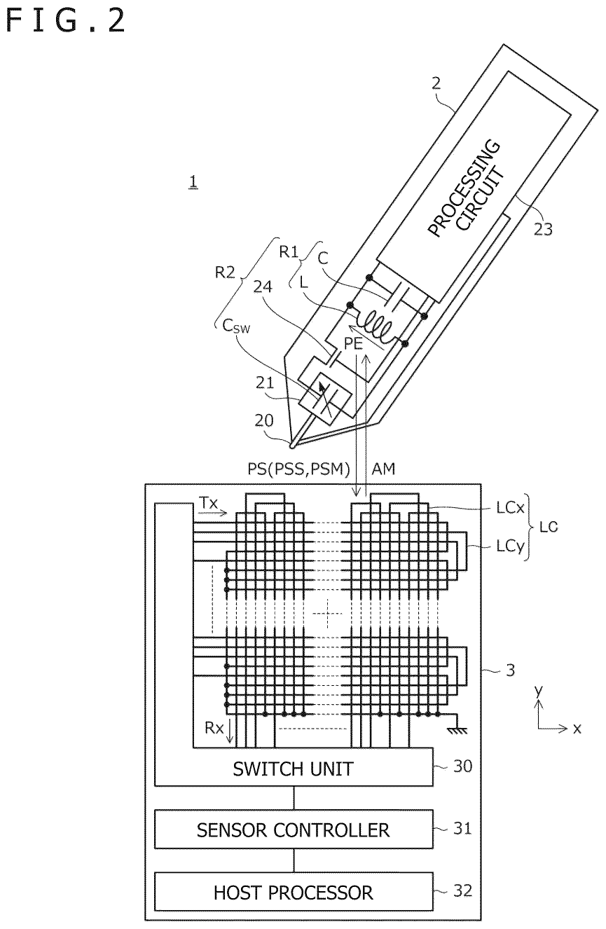

FIG. 2 is a diagram illustrating a configuration of a position detection system 1 according to a first embodiment of the present disclosure. As illustrated in the figure, the position detection system 1 includes an electromagnetic induction pen 2 and a position detecting device 3 that each support an electromagnetic induction system (EM R system).

The electromagnetic induction pen 2 is a pen-type device including a core body 20, a pressure sensor 21 including a variable capacitance capacitor C_{sw}, a processing circuit 23, a coil (inductance element) L, a capacitor (capacitance element) C, and a switch element 24. Of these, the coil L and the capacitor C constitute a first resonance circuit R1, and the coil L, the capacitor C, the variable capacitance capacitor C_{sw}, and the switch element 24 constitute a second resonance circuit R2. In one or more implementations, the processing circuit 23 includes a processor and a memory storing instructions that, when executed by the processor, cause the electromagnetic induction pen 2 to perform the acts of the electromagnetic induction pen 2 described herein.

The coil L and the capacitor C are connected in series with each other. The variable capacitance capacitor C_{sw} is connected in parallel with the capacitor C. The switch element 24 is connected in series with the variable capacitance capacitor C_{sw}. The switch element 24 is an on-off switch provided to switch between the first resonance circuit R1 and the second resonance circuit R2. The switch element 24 is subjected to on-off control by the processing circuit 23. In a concrete example, the switch element 24 is constituted by a JFET. When the processing circuit 23 turns off the switch element 24, the variable capacitance capacitor C_{sw} is disconnected from the circuit, and the first resonance circuit R1 becomes active. When the processing circuit 23 turns on the switch element 24, on the other hand, the variable capacitance capacitor C_{sw} is incorporated into the circuit, and the second resonance circuit R2 becomes active.

The variable capacitance capacitor C_{sw} is an element (changing element) that plays a role of changing the resonance frequency of the second resonance circuit R2 in relation to the behavior of the user. Incidentally, another kind of changing element such as a variable inductance or a variable resistance may be used in place of the variable capacitance capacitor C_{sw} or together with the variable capacitance capacitor C_{sw}.

The behavior of the user in the present embodiment is behavior of pressing the pen tip of the electromagnetic induction pen 2 against the panel surface. The pressure sensor 21 is a sensor for detecting the degree of the behavior. Specifically, the pressure sensor 21 is configured such that the capacitance of the variable capacitance capacitor C_{sw} changes according to a pressure applied to a distal end of the core body 20 (a value of this pressure will hereinafter be referred to as a “pen pressure value P”). The pen pressure value P is an analog quantity that changes continuously. The capacitance of the variable capacitance capacitor C_{sw} also changes continuously. Hence, transmission of the pen pressure value P by the electromagnetic induction pen 2 can be said to be transmission using analog modulation. Incidentally, another kind of behavior such as, for example, behavior of gripping the side surface of the electromagnetic induction pen 2 may be used as the behavior of the user. The variable capacitance capacitor C_{sw} in that case is included in a sensor for detecting the degree of the behavior rather than in the pressure sensor 21.

The position detecting device 3 is a device including a plurality of loop coils LC, a switch unit 30, a sensor controller 31, and a host processor 32. The position detecting device 3 according to a typical example is a tablet terminal or a notebook personal computer whose display surface serves also as a touch surface. However, the position detecting device 3 may be constituted by a digitizer or the like not having a display surface. In one or more implementations, the sensor controller 31 includes a processor and a memory storing instructions that, when executed by the processor, cause the sensor controller 31 to perform the acts of the sensor controller 31 described herein.

The plurality of loop coils LC are coils arranged within the touch surface. The plurality of loop coils LC include a plurality of loop coils LCx arranged side by side in an x-direction and a plurality of loop coils L Cy arranged side by side in a y-direction orthogonal to the x-direction. One end of each loop coil LC is connected to the switch unit 30, and another end thereof is grounded. The switch unit 30 is a circuit that plays a role of connecting one or more of the plurality of loop coils LC to the sensor controller 31 according to control of the sensor controller 31.

The sensor controller 31 is an integrated circuit that has functions of detecting the position of the electromagnetic induction pen 2 within the touch surface, obtaining the pen pressure value P transmitted by the electromagnetic induction pen 2, and sequentially supplying the detected position and the obtained pen pressure value P to the host processor 32. In order to perform these pieces of processing, the sensor controller 31 is configured to drive (that is, supply a driving current Tx to) the plurality of loop coils LCy in order or simultaneously, and receive induced currents Rx appearing in the plurality of loop coils LCx.

When the sensor controller 31 supplies the driving current Tx to the loop coils L Cy, an alternating magnetic field A M occurs on the touch surface. When the coil L of the electromagnetic induction pen 2 enters the alternating magnetic field AM, an electromotive force PE occurs across the coil L, a resonance circuit (the first resonance circuit R1 or the second resonance circuit R2) that is active at this time is set in a resonant state, and consequently an alternating magnetic field PS (pen signal) is sent out from the electromagnetic induction pen 2. In the following, the alternating magnetic field PS sent out from the electromagnetic induction pen 2 when the first resonance circuit R1 is active may be referred to as a “reference alternating magnetic field PSS,” and the alternating magnetic field PS sent out from the electromagnetic induction pen 2 when the second resonance circuit R2 is active may be referred to as a “modulated alternating magnetic field PSM.” The frequencies of the reference alternating magnetic field PSS and the modulated alternating magnetic field PSM are ideally equal to the resonance frequencies of the first resonance circuit R1 and the second resonance circuit R2, respectively. When expressed by concrete equations, the frequency f₁ of the reference alternating magnetic field PSS is expressed as f₁₌₁/(2π(LC)^{1/2}), and the frequency f₂ of the modulated alternating magnetic field PSM is expressed as f₂=1/(2π(L(C+C_{sw}))^{1/2}).

The sensor controller 31 is configured to receive the induced current Rx appearing in each of the plurality of loop coils L Cx by the alternating magnetic field PS, and detect the position of the electromagnetic induction pen 2 within the touch surface and obtain the pen pressure value P transmitted by the electromagnetic induction pen 2 on the basis of a result of the reception. Specifically, the sensor controller 31 is configured to detect the position of the electromagnetic induction pen 2 on the basis of the amplitude of the induced current Rx received in each loop coil LCx, while obtaining the pen pressure value P transmitted by the electromagnetic induction pen 2 on the basis of the frequency of the induced current Rx (=a frequency of the alternating magnetic field PS).

Here, description will be made of concrete processing of obtaining the pen pressure value P on the basis of the frequency of the induced current Rx. First, as a premise, the sensor controller 31 is configured to derive the phase of the induced current Rx at a predetermined frequency by performing a discrete Fourier transform (or a fast Fourier transform) of the induced current Rx by using a predetermined period after a timing of ending sending out of the alternating magnetic field AM. This predetermined frequency is, for example, an ideal frequency (that is, a frequency in a case where effects of parasitic capacitances and disturbances are not taken into consideration) of the reference alternating magnetic field PSS. The phase thus derived is a value reflecting the frequency of the induced current Rx because sending out of the alternating magnetic field PS by the electromagnetic induction pen 2 is started in a known timing, that is, immediately after sending out of the alternating magnetic field AM is ended. Hence, the sensor controller 31 obtains the derived phase as a value indicating the frequency of the induced current Rx, and obtains the pen pressure value P. Specifically, the sensor controller 31 stores, as the reference phase in advance, a phase phDh (first output) derived in a timing in which the electromagnetic induction pen 2 is transmitting the reference alternating magnetic field PSS, and the sensor controller 31 obtains a phase difference phCw-phDh by subtracting the reference phase from a phase phCw (the modulated phase; second output) derived in a timing in which the electromagnetic induction pen 2 is transmitting the modulated alternating magnetic field PSM. Then, the pen pressure value P transmitted by the electromagnetic induction pen 2 is obtained by converting a phase phC w-phDh-offset (third output) obtained by subtracting a given offset amount offset from the obtained difference phCw-phDh into a digital value by a predetermined conversion rule.

Concrete contents of the predetermined conversion rule are as in Equation (1) illustrated in the following. However, press in Equation (1) is a variable determined by Equation (2), and n is a predetermined numerical value larger than 1. Because n>1, an amount of change in the pen pressure value P with respect to a change in the amount of the behavior by the user (force of pressing the pen tip against the panel surface in this case) is increased as the amount of the behavior is increased. However, it is not essential that n>1, but n=1 or n<1 may be also used. In addition, PressMax in Equation (2) is a maximum level of the pen pressure value P (for example, 2047), and PhMax is the value of the phase phCw-phDh-offset in a case where the pen pressure at the maximum level is applied.

$$Math . 1$$

$$P = \{ \begin{matrix}0 & ( press < 0 ) \\ {press}^{n} & ( press \geq 0 )\end{matrix} \qquad ( 1 )$$

$$press = ( phCw - phDh - offset ) \times \frac{Press Max}{Ph Max} \qquad ( 2 )$$

The offset amount offset is used to absorb slight oscillations (see FIG. 1) appearing in the difference between the reference phase and the modulated phase. The oscillations can be absorbed more as the value of the offset amount offset is increased. However, when the value of the offset amount offset is made too large, an initial pen pressure becomes heavy (that is, drawing cannot be performed unless the pen tip of the electromagnetic induction pen 2 is strongly pressed against the panel surface). When the value of the offset amount offset is made too small, on the other hand, what is called an ink leakage (a phenomenon in which drawing is performed though no pen pressure is applied) occurs. In addition, the value of an appropriate offset amount offset changes according to not only the characteristics of the electromagnetic induction pen 2 and the position detecting device 3 but also an external environment such as an atmospheric temperature. Accordingly, the sensor controller 31 is configured to adjust the value of the offset amount offset by performing calibration processing while the electromagnetic induction pen 2 is hovering. Specifically, it suffices for the sensor controller 31 to derive the height (distance from the panel surface) of the electromagnetic induction pen 2 from a maximum amplitude of the induced current Rx appearing in the loop coils LCx, measure the difference phCw-phDh under conditions where the electromagnetic induction pen 2 is at a certain height or more and thus it can be surely considered that no pen pressure is applied, and determine the value of the offset amount offset such that a value obtained by subtracting the offset amount offset from the measured difference phCw-phDh is a predetermined value (for example, −30). This makes it possible to appropriately absorb slight oscillations appearing in the difference phCw-phDh.

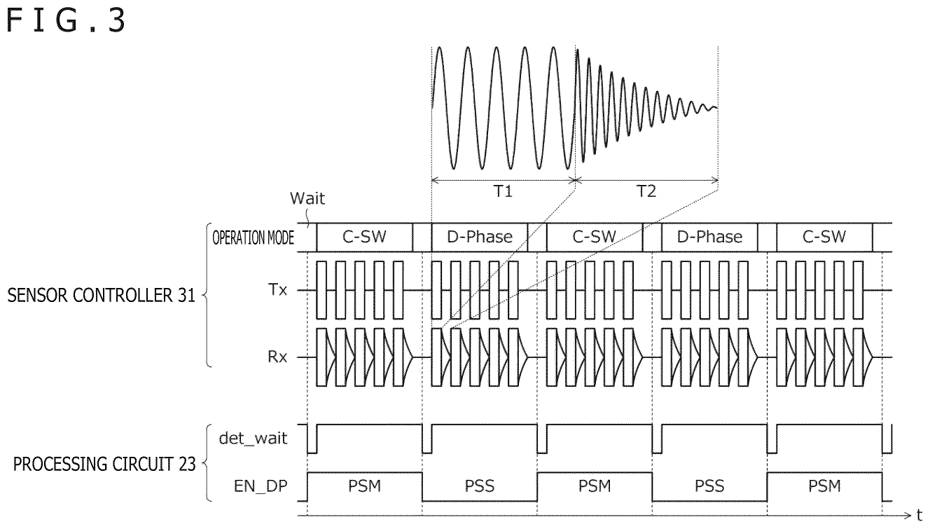

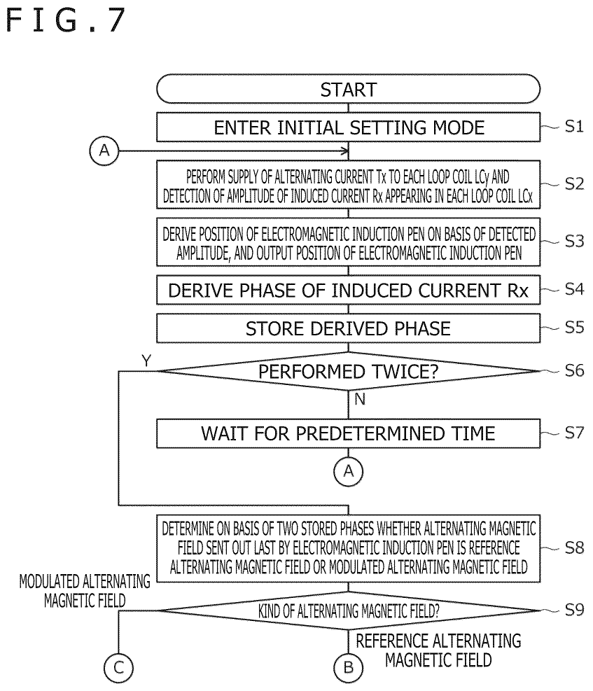

FIG. 3 is a diagram of assistance in explaining operation of the sensor controller 31 and the processing circuit 23 according to the present embodiment. First directing attention to the sensor controller 31, the sensor controller 31 is configured to operate in one of three operation modes Wait, D-Phase, and C-SW. The sensor controller 31 also has an initial setting mode. This will be described later with reference to a flowchart of FIG. 7.

The operation mode Wait is a mode for making the electromagnetic induction pen 2 perform switching of the alternating magnetic field to be sent out (that is, turn on or off the switch element 24). As will be described later in detail, the electromagnetic induction pen 2 is configured to switch on or off the switch element 24 in response to detecting that the sensor controller 31 has entered the operation mode Wait. The sensor controller 31 that has entered the operation mode Wait performs neither the supply of the alternating current Tx to the loop coils L Cy nor the reception of the induced current Rx in the loop coils L Cx for a predetermined time.

The operation mode D-Phase is a mode of obtaining the reference phase on the basis of a result of reception of the reference alternating magnetic field PSS sent out by the electromagnetic induction pen 2, and storing the reference phase. The sensor controller 31 that has entered the operation mode D-Phase repeatedly performs processing of supplying the alternating current Tx to loop coils L Cy over a predetermined time T1 a predetermined number of times at intervals of a predetermined time T2 while changing the loop coils L Cy. In addition, during the predetermined time T2 during which the supply of the alternating current Tx is stopped, the phase of the induced current Rx appearing in the loop coils L Cx is derived as described above, and the phase obtained as a result is stored as the reference phase.

The operation mode C-SW is a mode of obtaining the pen pressure value P transmitted by the electromagnetic induction pen 2 on the basis of a result of reception of the modulated alternating magnetic field PSM sent out by the electromagnetic induction pen 2. The sensor controller 31 that has entered the operation mode C-SW repeatedly performs processing of supplying the alternating current Tx to loop coils LCy over the predetermined time T1 a predetermined number of times at intervals of the predetermined time T2 as in the case of the operation mode D-Phase. In addition, during the predetermined time T2 during which the supply of the alternating current Tx is stopped, the phase of the induced current Rx appearing in the loop coils L Cx is derived as described above. Then, the pen pressure value P is derived on the basis of a phase difference obtained by subtracting the reference phase from the derived phase. A concrete method of deriving the pen pressure value P is as described above.

Next directing attention to the processing circuit 23, a wait detection signal det_wait and a D-Phase enable signal EN_DP illustrated in the figure are each a signal generated from the alternating magnetic field AM by the processing circuit 23. The processing circuit 23 is configured to hold the wait detection signal det_wait HIGH while the alternating magnetic field AM is received, and set the wait detection signal det_wait LOW when a predetermined time or more has passed after the alternating magnetic field AM is not received. This predetermined time is set to be a time length slightly shorter than the length of time during which the sensor controller 31 is in the operation mode Wait. Hence, the wait detection signal det_wait is changed to be temporarily LOW each time the sensor controller 31 enters the operation mode Wait.

In addition, the processing circuit 23 is configured to switch the value of the D-Phase enable signal EN_DP between HIGH and LOW in response to changing of the wait detection signal det_wait to LOW. Then, the processing circuit 23 is configured to turn off the switch element 24 when the D-Phase enable signal EN_DP is LOW and turn on the switch element 24 when the D-Phase enable signal EN_DP is HIGH. The electromagnetic induction pen 2 thereby operates while switching between a state of sending out the reference alternating magnetic field PSS by using the first resonance circuit R1 and a state of sending out the modulated alternating magnetic field PSM by using the second resonance circuit R2 each time the sensor controller 31 enters the operation mode Wait.

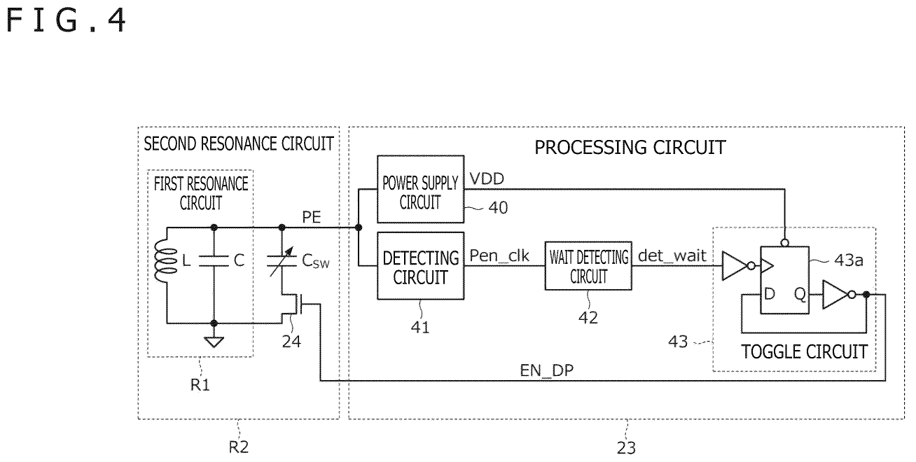

FIG. 4 is a diagram illustrating an internal configuration of the processing circuit 23 for implementing the operation described with reference to FIG. 3. As illustrated in the figure, the processing circuit 23 includes a power supply circuit 40, a detecting circuit 41, a wait detecting circuit 42, and a toggle circuit 43.

The power supply circuit 40 is a circuit that generates a power supply voltage VDD necessary for the operation of the processing circuit 23 by using the electromotive force PE generated in the first resonance circuit R1 by the alternating magnetic field AM. The detecting circuit 41 is a circuit that generates a clock signal Pen_clk on the basis of the electromotive force PE. The wait detecting circuit 42 is a circuit that generates the wait detection signal det_wait on the basis of the clock signal Pen_clk. The wait detection signal det_wait generated by the wait detecting circuit 42 is supplied to the toggle circuit 43.

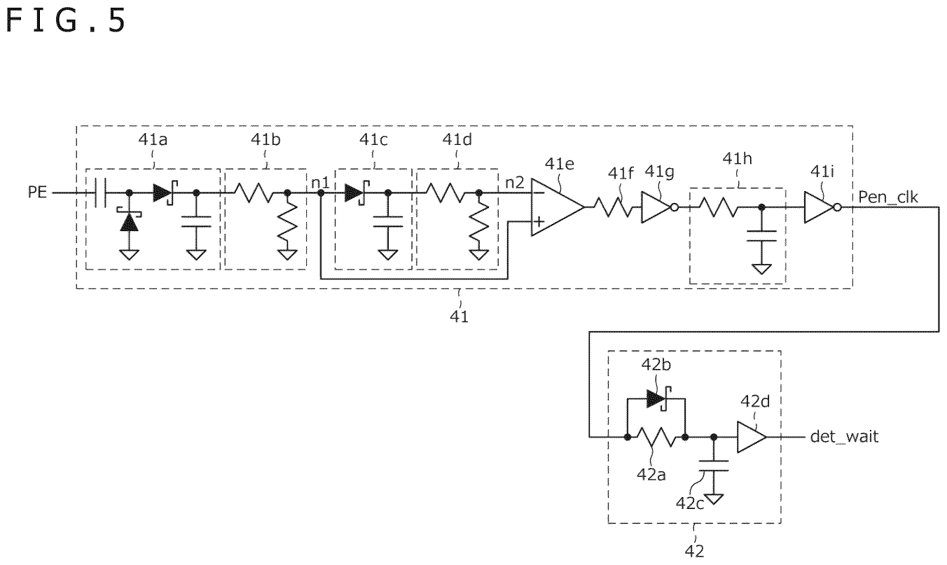

FIG. 5 is a diagram illustrating a detailed configuration of the detecting circuit 41 and the wait detecting circuit 42. As illustrated in the figure, the detecting circuit 41 includes a half-wave voltage doubler rectifier circuit 41a formed by using Schottky barrier diodes, a voltage dividing circuit 41b, a smoothing circuit 41c formed by using a Schottky barrier diode, a voltage dividing circuit 41d, an operational amplifier 41e, a resistive element 41f, an inverting buffer circuit 41g, an RC low-pass filter 41h, and an inverting buffer circuit 41i.

The half-wave voltage doubler rectifier circuit 41a, the voltage dividing circuit 41b, the smoothing circuit 41c, and the voltage dividing circuit 41d are connected in series with each other in this order. An input node of the half-wave voltage doubler rectifier circuit 41a constitutes an input node of the detecting circuit 41, and is supplied with the electromotive force PE from the first resonance circuit R1. A non-inverting input terminal of the operational amplifier 41e is connected to an output node n1 of the voltage dividing circuit 41b. An inverting input terminal of the operational amplifier 41e is connected to an output node n2 of the voltage dividing circuit 41d. The resistive element 41f, the inverting buffer circuit 41g, the RC low-pass filter 41h, and the inverting buffer circuit 41i are connected in series with each other in this order between an output terminal of the operational amplifier 41e and an output node of the detecting circuit 41. A signal output from the output node of the detecting circuit 41 is the clock signal Pen_clk illustrated in FIG. 4.

In addition, the wait detecting circuit 42 includes a resistive element 42a, a Schottky barrier diode 42b, a capacitor 42c, and a Schmitt trigger circuit 42d. The resistive element 42a is connected between an input node of the wait detecting circuit 42 to which the clock signal Pen_clk is input and an input terminal of the Schmitt trigger circuit 42d. The Schottky barrier diode 42b is connected in parallel with the resistive element 42a in a direction in which an anode thereof is connected to the input node of the wait detecting circuit 42. The capacitor 42c is connected between the input terminal of the Schmitt trigger circuit 42d and a grounding terminal. An output terminal of the Schmitt trigger circuit 42d constitutes an output node of the wait detecting circuit 42. A signal output from the output node of the wait detecting circuit 42 is the wait detection signal det_wait illustrated in FIG. 4.

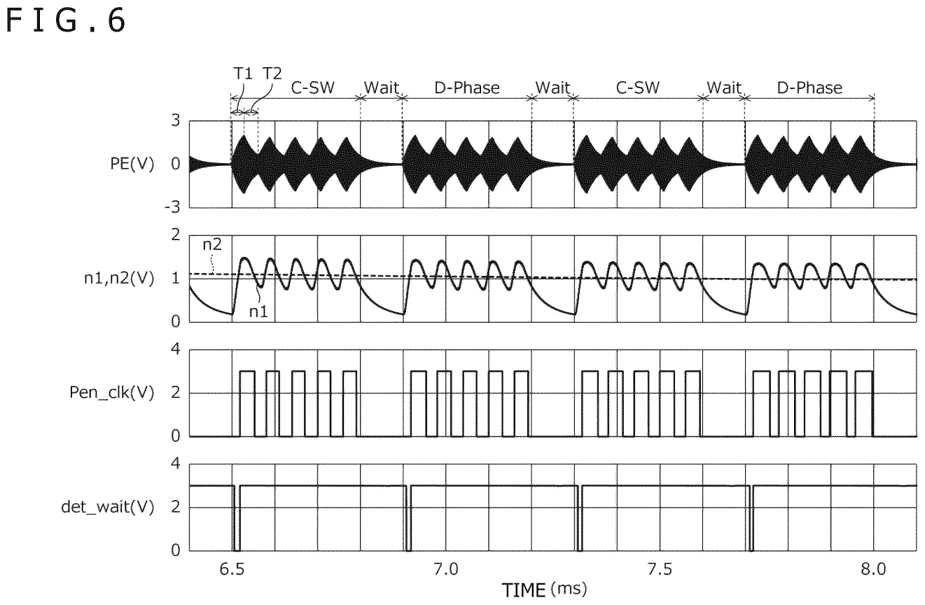

FIG. 6 is a diagram illustrating a result of simulation of the electromotive force PE, waveforms appearing at the output nodes n1 and n2, the clock signal Pen_clk, and the wait detection signal det_wait. An upper part of the figure illustrates corresponding operation modes of the sensor controller 31.

Predetermined times T1 and T2 illustrated in FIG. 6 correspond to the predetermined times T1 and T2 illustrated in FIG. 3. The electromotive force PE gradually rises and charges the capacitor C illustrated in FIG. 2 and FIG. 4 during the predetermined time T1 during which the sensor controller 31 is sending out the alternating magnetic field AM. When the predetermined time T1 has passed, sending out of the alternating magnetic field AM by the sensor controller 31 is stopped, and a discharge from the capacitor C is started. This discharge causes the alternating magnetic field PS to be sent out from the coil L. When the switch element 24 is on, the variable capacitance capacitor C_{sw} is also subjected to this charge and discharge.

The waveform appearing at the output node n1 results from rectification and voltage division of the waveform of the electromotive force PE. In addition, the waveform appearing at the output node n2 results from smoothing and voltage division of the waveform appearing at the output node n1. The clock signal Pen_clk is a binary signal that is HIGH when the waveform appearing at the output node n1 is larger than the waveform appearing at the output node n2 and that is LOW when the waveform appearing at the output node n1 is smaller than the waveform appearing at the output node n2, due to action of the operational amplifier 41e illustrated in FIG. 5. As a result, the clock signal Pen_clk thus generated is HIGH when the alternating magnetic field AM from the sensor controller 31 reaches the coil L, and is LOW when the alternating magnetic field AM does not reach the coil L.

The wait detection signal det_wait is a signal that maintains HIGH while the clock signal Pen_clk is HIGH, and which becomes LOW when a predetermined time or more has passed since the clock signal Pen_clk becomes LOW. Concretely describing the operation of the wait detecting circuit 42 for generating such a wait detection signal det_wait by referring to FIG. 5 again, when the clock signal Pen_clk is HIGH, a current from the detecting circuit 41 flows in through the Schottky barrier diode 42b, and thereby the potential of an electrode on the detecting circuit 41 side of the capacitor 42c rises quickly. As a result, the wait detection signal det_wait, which is the output of the Schmitt trigger circuit 42d, also becomes HIGH at substantially the same time as the clock signal Pen_clk becomes HIGH. When the clock signal Pen_clk becomes LOW, on the other hand, a current flows from the capacitor 42c through the resistive element 42a to the detecting circuit 41 due to a discharge of the capacitor 42c. When the discharge of the capacitor 42c progresses, and the input voltage of the Schmitt trigger circuit 42d falls below a predetermined value, the wait detection signal det_wait, which is the output of the Schmitt trigger circuit 42d, changes to LOW. The wait detection signal det_wait is the above-described signal as a result of the operation of the wait detecting circuit 42 as described above.

The description returns to FIG. 4. The toggle circuit 43 is a circuit for switching between a state of sending out the reference alternating magnetic field PSS by using the first resonance circuit R1 and a state of sending out the modulated alternating magnetic field PSM by using the second resonance circuit R2. The toggle circuit 43 includes a D-type flip-flop circuit 43a. A clock terminal of the flip-flop circuit 43a is supplied with an inverted signal of the wait detection signal det_wait. A data terminal of the flip-flop circuit 43a is supplied with an inverted signal of an output terminal. An output signal of the toggle circuit 43 is the D-Phase enable signal EN_DP, which is illustrated also in FIG. 3. Thus, the D-Phase enable signal EN_DP is a signal that switches between HIGH and LOW in response to changing of the wait detection signal det_wait to LOW. As illustrated in FIG. 4, the D-Phase enable signal EN_DP is supplied to a gate of the switch element 24. Thus, switching between sending out of the reference alternating magnetic field PSS and sending out of the modulated alternating magnetic field PSM is performed at falling edges of the wait detection signal det_wait.

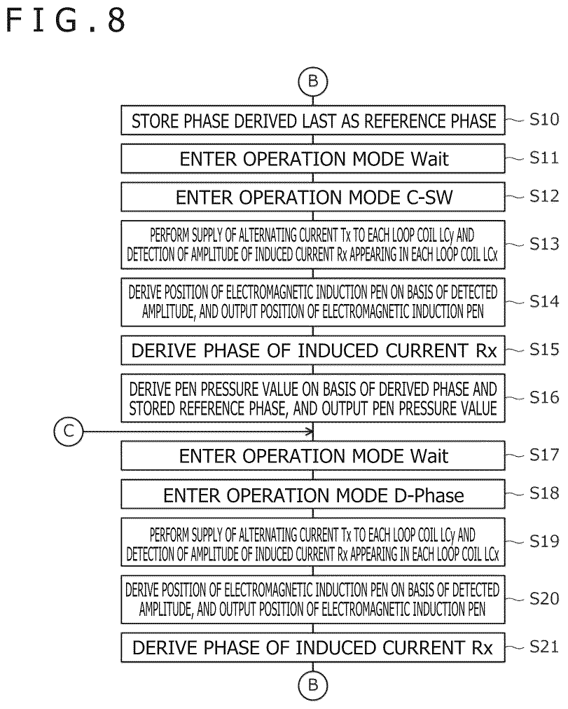

FIG. 7 and FIG. 8 are a flowchart illustrating processing performed by the sensor controller 31 according to the present embodiment. In the following, the operation of the sensor controller 31 according to the present embodiment will be described in more detail with reference to these drawings.

Referring first to FIG. 7, the sensor controller 31 first enters the initial setting mode (step S1). The initial setting mode is an operation mode for grasping a timing of sending out of the reference alternating magnetic field PSS and the modulated alternating magnetic field PSM by the electromagnetic induction pen 2.

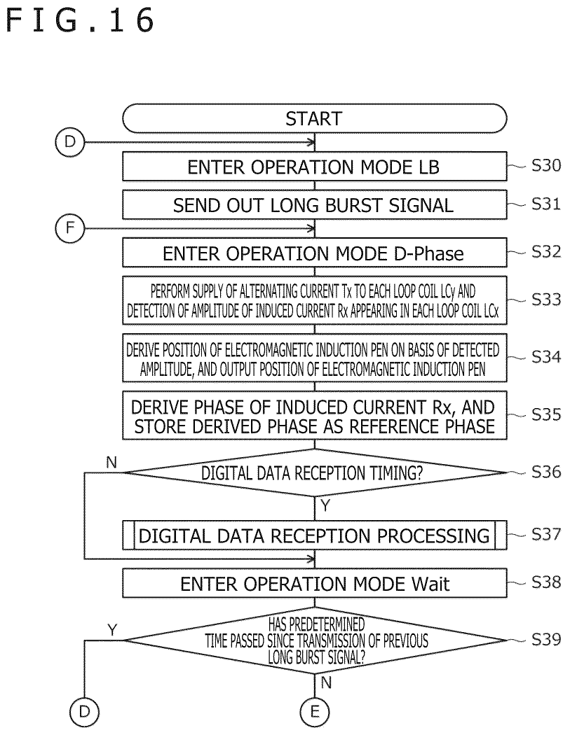

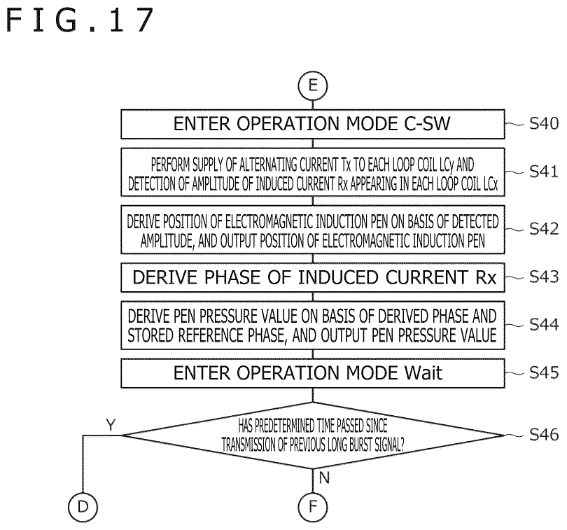

Entering the initial setting mode, the sensor controller 31 performs the supply of the alternating current Tx to each loop coil LCy and the detection of the amplitude of the induced current Rx appearing in each loop coil LCx (step S2). Incidentally, in a case where the sensor controller 31 has already detected the position of the electromagnetic induction pen 2 at this time point, it suffices for the sensor controller 31 to perform step S2 for only a predetermined number of loop coils L Cy and a predetermined number of loop coils LCx located in the vicinity of the already detected position. This applies also to steps S13 and S19 (see FIG. 8), step S33 (see FIG. 16), and step S41 (see FIG. 17) to be described later.

Next, the sensor controller 31 derives the position of the electromagnetic induction pen 2 on the basis of the amplitude of the induced current Rx in each loop coil L Cy, which is detected in step S3, and outputs the position of the electromagnetic induction pen 2 to the host processor 32 (step S3). In addition, the sensor controller 31 derives the phase of the induced current Rx in a loop coil LCx whose amplitude detected in step S3 is largest (step S4), and stores the derived phase (step S5).

The sensor controller 31 thereafter determines whether or not the processing of steps S2 to S5 has been performed twice (step S6). When determining, as a result, that the processing of steps S2 to S5 has not been performed twice, the sensor controller 31 waits for a predetermined time (step S7), and thereafter returns to step S3 to repeat the processing. Step S7 is processing for making the electromagnetic induction pen 2 switch the alternating magnetic field PS to be sent out. The sensor controller 31 waits without performing either of the supply of the alternating current Tx to the loop coil L Cy and the reception of the induced current Rx in the loop coil L Cx over substantially the same time as the duration of the operation mode Wait.

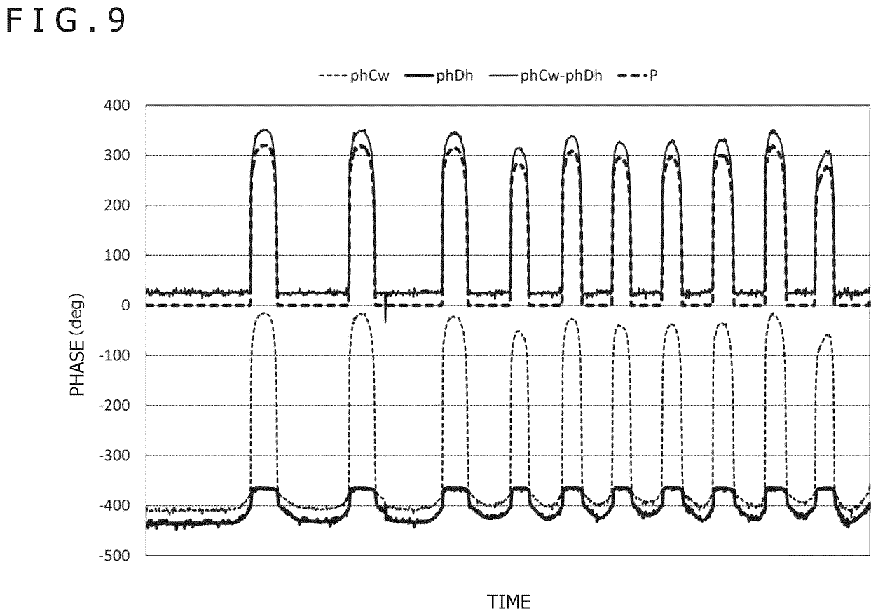

When determining, in step S6, that the processing of steps S2 to S5 has been performed twice, the sensor controller 31 determines, on the basis of the two phases stored in two times of step S5, whether the alternating magnetic field PS sent out last by the electromagnetic induction pen 2 is the reference alternating magnetic field PSS or the modulated alternating magnetic field PSM (steps S8 and S9). Specifically, it suffices to make this determination on the basis of the magnitude of the two phases. As illustrated in FIG. 9 below, the modulated phase has a larger value than the reference phase irrespective of the presence or absence of the pen pressure. Thus, the sensor controller 31 can distinguish the modulated phase and the reference phase from each other on the basis of the magnitude of the two phases. Then, when the sensor controller 31 determines that the alternating magnetic field PS sent out last by the electromagnetic induction pen 2 is the reference alternating magnetic field PSS, the sensor controller 31 advances the processing to step S10 in FIG. 8. When the sensor controller 31 determines that the alternating magnetic field PS sent out last by the electromagnetic induction pen 2 is the modulated alternating magnetic field PSM, the sensor controller 31 advances the processing to step S17 in FIG. 8.

Proceeding to FIG. 8, the sensor controller 31 in step S10 stores the last derived phase as the reference phase. Then, after waiting for a predetermined time by entering the operation mode Wait (step S11), the sensor controller 31 enters the operation mode C-SW (step S12), and performs the supply of the alternating current Tx to each loop coil LCy and the detection of the amplitude of the induced current Rx appearing in each loop coil LCx (step S13).

Next, the sensor controller 31 derives the position of the electromagnetic induction pen 2 on the basis of the amplitude of the induced current Rx in each loop coil LCy, which is detected in step S13, and outputs the position of the electromagnetic induction pen 2 to the host processor 32 (step S14). In addition, the sensor controller 31 derives the phase of the induced current Rx in a loop coil L Cx whose amplitude detected in step S15 is largest (step S16). Then, the sensor controller 31 derives the pen pressure value P transmitted by the electromagnetic induction pen 2 on the basis of the derived phase and the reference phase stored in the immediately preceding step S10, and outputs the pen pressure value P to the host processor 32 (step S17). A concrete method of deriving the pen pressure value P is as described above.

Next, the sensor controller 31 waits for a predetermined time by entering the operation mode Wait again (step S17), thereafter enters the operation mode D-Phase (step S18), and performs the supply of the alternating current Tx to each loop coil L Cy and the detection of the amplitude of the induced current Rx appearing in each loop coil LCx (step S19).

Next, the sensor controller 31 derives the position of the electromagnetic induction pen 2 on the basis of the amplitude of the induced current Rx in each loop coil LCy, which is detected in step S19, and outputs the position of the electromagnetic induction pen 2 to the host processor 32 (step S20). In addition, the sensor controller 31 derives the phase of the induced current Rx in a loop coil L Cx whose amplitude detected in step S15 is largest (step S21), and stores the derived phase as the reference phase (step S10). Subsequent processing is as described above. The sensor controller 31 thereafter repeatedly performs the operation mode Wait, the operation mode C-SW, the operation mode Wait, and the operation mode D-Phase in this order.

As described above, according to the position detection system 1 in accordance with the present embodiment, the reference alternating magnetic field and the modulated alternating magnetic field can be sent out alternately from the electromagnetic induction pen 2 even when sending out of an alternating magnetic field over a predetermined time or more is not performed from the position detecting device 3. Hence, the accuracy of detection of the value indicating the behavior of the user, including the pen pressure value P, can be improved more than conventional.

In addition, according to the position detection system 1 in accordance with the present embodiment, the sensor controller 31 identifies the kind of the alternating magnetic field PS (the reference alternating magnetic field PSS or the modulated alternating magnetic field PSM), and therefore the sensor controller 31 can correctly receive the reference alternating magnetic field PSS and the modulated alternating magnetic field PSM autonomously sent out by the electromagnetic induction pen 2 in predetermined order. Hence, unlike a second embodiment to be described later, the order of transmission of the alternating magnetic field PS by the electromagnetic induction pen 2 does not need to be reset from the sensor controller 31. It is therefore possible to use, as the electromagnetic induction pen 2, a type that generates power from the alternating magnetic field A M as described in the present embodiment and a type that operates on power supplied from a built-in battery (that is, a type that performs unidirectional communication from the electromagnetic induction pen 2; an EM type). In a case of using an electromagnetic induction pen 2 of the latter type, switching between sending out of the reference alternating magnetic field PSS and sending out of the modulated alternating magnetic field PSM within the electromagnetic induction pen 2 is performed at edges of a clock signal output from a built-in oscillator rather than at falling edges of the wait detection signal det_wait.

In addition, according to the position detection system 1 in accordance with the present embodiment, the offset amount offset is subtracted from the difference phCw-phDh, and therefore a difference between the frequency of the reference alternating magnetic field and the frequency of the modulated alternating magnetic field can be set as a hover indication value when no pressure is applied to the pen tip of the electromagnetic induction pen 2. It is to be noted that, while the subtraction is performed in the present embodiment, the offset amount offset may, needless to say, be added to the difference phCw-phDh, depending on a method of calculating the pen pressure value P or the like.

FIG. 9 is a diagram illustrating a result of measurement of temporal changes in the modulated phase phCw, the reference phase phDh, the difference phCw-phDh, and the pen pressure value P obtained in the sensor controller 31 according to the present embodiment. Parts where the phase phCw is increased in the figure are parts where the pen tip of the electromagnetic induction pen 2 is pressed against the panel surface. In the other parts, the pen tip of the electromagnetic induction pen 2 is in a state of being separated from the panel surface (hovering state).

As illustrated in FIG. 9, according to the position detection system 1 in accordance with the present embodiment, the pen pressure value P is 0 during hovering even though the difference phC w-phDh is not 0 even during the hovering. Hence, according to the position detection system 1 in accordance with the present embodiment, it can be said to be unnecessary to implement, in a drawing application, processing for essentially determining whether or not a pressure is applied to the pen tip.

Incidentally, in the present embodiment, the sensor controller 31 is configured to store the phase of the induced current Rx (a phase of the alternating magnetic field PS) in step S5 in FIG. 7, and identify the kind of the alternating magnetic field PS sent out by the electromagnetic induction pen 2 in step S8 on the basis of the two stored phases. However, the sensor controller 31 may store the frequency or amplitude of the induced current Rx (a frequency or amplitude of the alternating magnetic field PS) in step S5 in FIG. 7, and identify the kind of the alternating magnetic field PS sent out by the electromagnetic induction pen 2 in step S8 on the basis of two stored frequencies or amplitudes.

In addition, instead of steps S6, S8, and S9 in FIG. 7, whether or not the alternating magnetic field PS sent out by the electromagnetic induction pen is the reference alternating magnetic field PSS may be determined when the phase (or the frequency or amplitude) of the induced current Rx satisfies a predetermined condition. It suffices for the sensor controller 31 in this case to repeatedly perform the processing of steps S2 to S5 while step S7 is interposed until a determination result indicating that the alternating magnetic field PS sent out by the electromagnetic induction pen is the reference alternating magnetic field PSS is obtained, and advance the processing to step S10 when the determination result indicating that the alternating magnetic field PS sent out by the electromagnetic induction pen is the reference alternating magnetic field PSS is obtained.

A position detection system 1 according to a second embodiment of the present disclosure will next be described. The position detection system 1 according to the present embodiment is different from the position detection system 1 according to the first embodiment in that digital data (a set of bit values that are “0” or “1”) is transmitted from the electromagnetic induction pen 2 to the position detecting device 3 and in that the order of sending out the reference alternating magnetic field PSS and the modulated alternating magnetic field PSM by the electromagnetic induction pen 2 is reset from the position detecting device 3. The position detection system 1 according to the present embodiment is otherwise similar to the position detection system 1 according to the first embodiment. Thus, in the following, the description will be continued with attention directed to differences from the position detection system 1 according to the first embodiment.

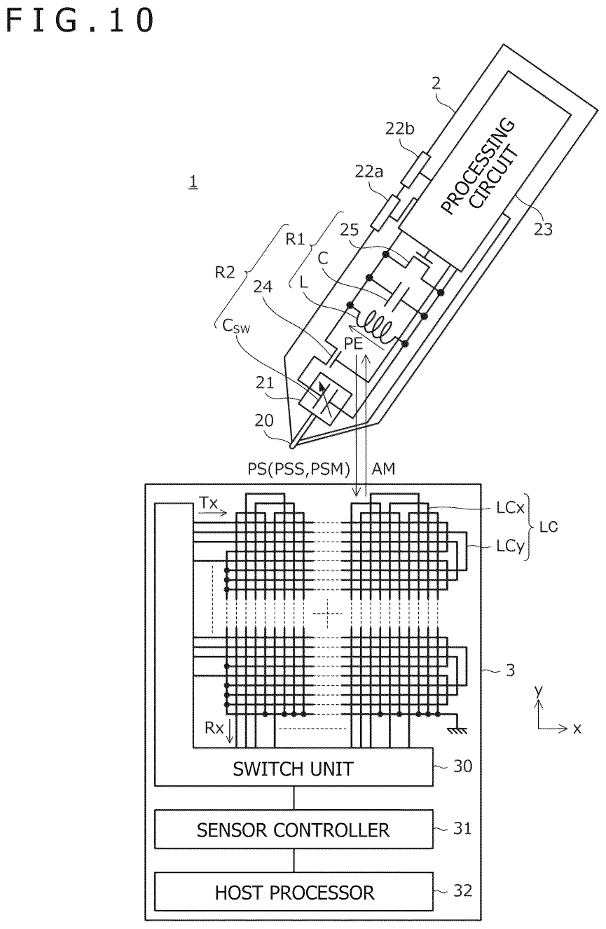

FIG. 10 is a diagram illustrating a configuration of the position detection system 1 according to the present embodiment. Differences from the position detection system 1 illustrated in FIG. 2 lie in that the electromagnetic induction pen 2 has side switches 22a and 22b and in that the first resonance circuit R1 has a switch element 25.

Each of the side switches 22a and 22b is an on-off switch provided to the surface of a casing of the electromagnetic induction pen 2. Each of the side switches 22a and 22b is configured to be capable of on/off operations by the user. The processing circuit 23 is configured to be able to obtain each of on/off states of the side switches 22a and 22b as one-bit on/off information. The processing circuit 23 according to the present embodiment is configured to have a function of generating four-bit digital data indicating identification information (two-bit information) of the electromagnetic induction pen 2 written within the processing circuit 23 in advance and transmitting the digital data to the position detecting device 3 in addition to the on/off information in timings specified by the position detecting device 3.

The switch element 25 is an on-off switch connected in parallel with the capacitor C. The switch element 25 is subjected to on-off control by the processing circuit 23. In a concrete example, the switch element 25 is constituted by a JFET. Operation in a case where the switch element 25 is off is as described in the first embodiment. When the processing circuit 23 turns on the switch element 25, the coil L is short-circuited, and therefore neither the first resonance circuit R1 nor the second resonance circuit R2 functions as a resonance circuit, so that the alternating magnetic field PS is not sent out from the electromagnetic induction pen 2. The processing circuit 23 transmits a bit value by utilizing this. Specifically, the switch element 25 is controlled to be off when “1” is transmitted, whereas the switch element 25 is controlled to be on when “0” is transmitted. Thus, the alternating magnetic field PS (the reference alternating magnetic field PSS or the modulated alternating magnetic field PSM) is sent out from the electromagnetic induction pen 2 as usual when “1” is transmitted, whereas the alternating magnetic field PS is not sent out from the electromagnetic induction pen 2 when “0” is transmitted. The sensor controller 31 can therefore demodulate the bit value transmitted by the electromagnetic induction pen 2 by an on-off modulation system, which is a kind of amplitude shift keying system.

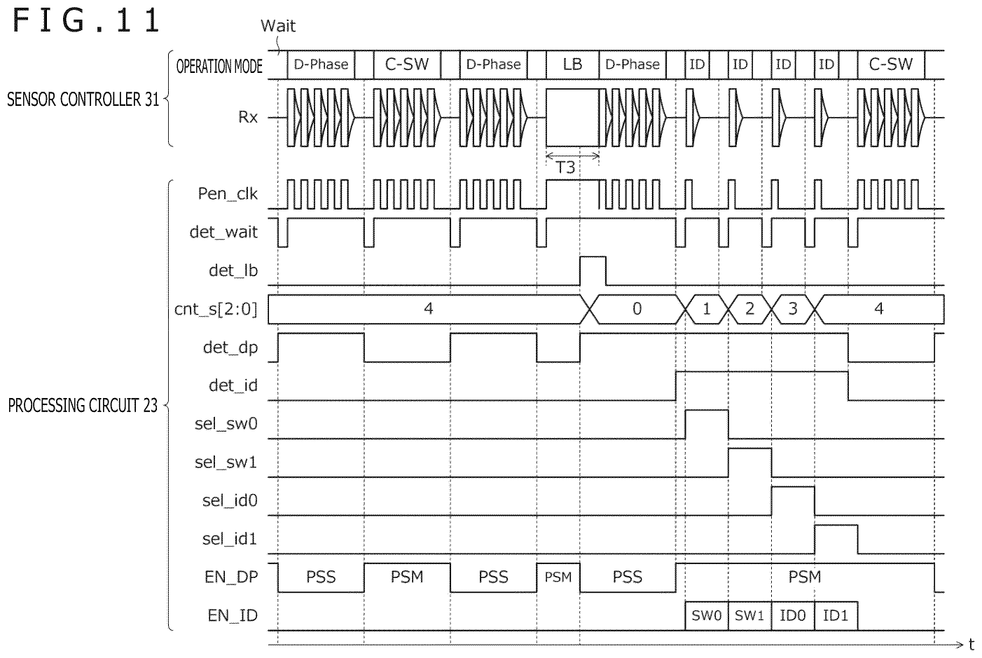

FIG. 11 is a diagram of assistance in explaining operation of the sensor controller 31 and the processing circuit 23 according to the present embodiment. The sensor controller 31 according to the present embodiment configured to be operable not only in the three operation modes Wait, D-Phase, and C-SW illustrated in FIG. 3 but also in operation modes LB and ID. Incidentally, as will be described in detail in the following, in the present embodiment, the order of sending out the reference alternating magnetic field PSS and the modulated alternating magnetic field PSM by the electromagnetic induction pen 2 is reset from the position detecting device 3, and therefore the initial setting mode illustrated in FIG. 7 is not necessary in the sensor controller 31 according to the present embodiment.

The operation mode LB is a mode for resetting the order of sending out the reference alternating magnetic field PSS and the modulated alternating magnetic field PSM by the electromagnetic induction pen 2 and resetting a three-bit counter cnt_s (to be described later) provided within the electromagnetic induction pen 2 by forcibly activating the first resonance circuit R1 (that is, turning off the switch element 24) within the electromagnetic induction pen 2. Entering the operation mode LB, the sensor controller 31 continues to perform processing of supplying the alternating current Tx to each loop coil LCy over a predetermined time T3, which is longer than the predetermined times T1 and T2 illustrated in FIG. 3. Thus, the alternating magnetic field AM is continuously sent out from the panel surface over the predetermined time T3. In the following, the alternating magnetic field A M thus sent out will be referred to as a “long burst signal.” As will be described later in detail, the first resonance circuit R1 becomes active within the electromagnetic induction pen 2 after the operation mode LB. Thus, the sensor controller 31 after ending the operation in the operation mode LB enters the operation mode D-Phase.

The operation mode ID is a mode for making the electromagnetic induction pen 2 transmit the digital data. The electromagnetic induction pen 2 is configured to transmit one-bit data (bit value) for each time of the operation mode ID by using an on/off state of the switch element 25 described above. The data thus transmitted is a discrete digital quantity. This transmission is therefore transmission using digital modulation. The sensor controller 31 demodulates the bit value transmitted by the electromagnetic induction pen 2 on the basis of whether or not the induced current Rx is received after sending out of the alternating magnetic field AM. As described above, the digital data transmitted by the electromagnetic induction pen 2 is four-bit data. The sensor controller 31 is therefore configured to receive all of the digital data of four bits by entering the operation mode ID four times while the operation mode Wait is interposed.

The processing circuit 23 according to the present embodiment is configured to operate by using not only the clock signal Pen_clk, the wait detection signal det_wait, and the D-Phase enable signal EN_DP described in the first embodiment but also a long burst detection signal det_Ib, a three-bit counter cnt_s, a D-Phase detection signal det_dp, a digital data transmission period detection signal det_id, a first side switch selection signal sel_sw0, a second side switch selection signal sel_sw1, a first identification information selection signal sel_id0, a second identification information selection signal sel_id1, and a digital data transmission enable signal EN_ID.

As described in the first embodiment, the clock signal Pen_clk is a signal that is HIGH when the alternating magnetic field AM from the sensor controller 31 reaches the coil L, and which is LOW when the alternating magnetic field AM from the sensor controller 31 does not reach the coil L. The processing circuit 23 is configured to hold the long burst detection signal det_Ib LOW when the clock signal Pen_clk is LOW, and set the long burst detection signal det_Ib HIGH when a HIGH state of the clock signal Pen_clk has continued for a predetermined time or more. The long burst detection signal det_Ib is thereby a signal that changes to HIGH only when the long burst signal is received from the sensor controller 31.

The three-bit counter cnt_s is a counter that defines the order of the digital data transmitted by the electromagnetic induction pen 2. The processing circuit 23 is configured to reset the value of the three-bit counter cnt_s to zero in response to the long burst detection signal det_Ib becoming HIGH, and thereafter increment the value of the three-bit counter cnt_s by one each time the wait detection signal det_wait becomes LOW. This increment is continued until the value of the three-bit counter cnt_s becomes four. After the value of the three-bit counter cnt_s becomes four, the state of four is maintained until the long burst detection signal det_Ib becomes HIGH again.

The D-Phase detection signal det_dp is a signal indicating resonance circuit switching timing. The processing circuit 23 is in principle configured to switch the value of the D-Phase detection signal det_dp between HIGH and LOW in response to changing of the wait detection signal det_wait to LOW. However, the processing circuit 23 is configured not to switch the value of the D-Phase detection signal det_dp when the value of the three-bit counter cnt_s is one to three and when the wait detection signal det_wait changes to LOW for the first time since the value of the three-bit counter cnt_s becomes four. This is to prevent resonance circuit switching from occurring during the transmission of the digital data. In addition, the processing circuit 23 is configured to set the value of the D-Phase detection signal det_dp HIGH in response to changing of the long burst detection signal det_Ib to LOW. This is a configuration for forcibly activating the first resonance circuit R1 by the long burst signal. The order of sending out the reference alternating magnetic field PSS and the modulated alternating magnetic field PSM by the electromagnetic induction pen 2 is thereby reset.

The digital data transmission period detection signal det_id is a signal indicating a transmission period of the digital data. The processing circuit 23 is configured to set the value of the digital data transmission period detection signal det_id HIGH in response to changing of the wait detection signal det_wait to LOW when the value of the three-bit counter cnt_s is zero, and set the value of the digital data transmission period detection signal det_id LOW in response to changing of the wait detection signal det_wait to LOW for the first time after the value of the three-bit counter cnt_s returns to four.

The first side switch selection signal sel_sw0 is a signal indicating a transmission timing of the on/off information of the side switch 22a illustrated in FIG. 10. The processing circuit 23 is configured to hold the first side switch selection signal sel_sw0 HIGH over a predetermined time in response to changing of the value of the three-bit counter cnt_s to one. In addition, the second side switch selection signal sel_sw1 is a signal indicating a transmission timing of the on/off information of the side switch 22b illustrated in FIG. 10. The processing circuit 23 is configured to hold the second side switch selection signal sel_sw1 HIGH over a predetermined time in response to changing of the value of the three-bit counter cnt_s to two.

The first identification information selection signal sel_id0 and the second identification information selection signal sel_id1 are respectively signals indicating transmission timings of a first bit and a second bit of the identification information (two-bit information) of the electromagnetic induction pen 2 described above. The processing circuit 23 is configured to hold the first identification information selection signal sel_id0 HIGH over a predetermined time in response to changing of the value of the three-bit counter cnt_s to three. In addition, the processing circuit 23 is configured to hold the second identification information selection signal sel_id1 HIGH over a predetermined time in response to changing of the value of the three-bit counter cnt_s to four.

The D-Phase enable signal EN_DP is a control signal for the switch element 24 illustrated in FIG. 10. The processing circuit 23 is configured to set an inverted signal of the D-Phase detection signal det_dp as the D-Phase enable signal EN_DP when the digital data transmission period detection signal det_id is LOW, and fix the D-Phase enable signal EN_DP to HIGH when the digital data transmission period detection signal det_id is HIGH. Because the D-Phase enable signal EN_DP is fixed to HIGH when the digital data transmission period detection signal det_id is HIGH, the electromagnetic induction pen 2 transmits the digital data by using on-off modulation of the modulated alternating magnetic field PSM. The processing circuit 23 may fix the D-Phase enable signal EN_DP to LOW when the digital data transmission period detection signal det_id is HIGH. The transmission of the digital data in that case is performed by on-off modulation of the reference alternating magnetic field PSS.

The digital data transmission enable signal EN_ID is a control signal for the switch element 25 illustrated in FIG. 10. The processing circuit 23 is configured to set the digital data transmission enable signal EN_ID LOW when a bit value to be transmitted is “1,” and set the digital data transmission enable signal EN_ID HIGH when the bit value to be transmitted is “0.” The control of the switch element 25 described above (turning off the switch element 25 in a case of transmission of “1,” and turning on the switch element 25 in a case of transmission of “0”) is thereby realized.

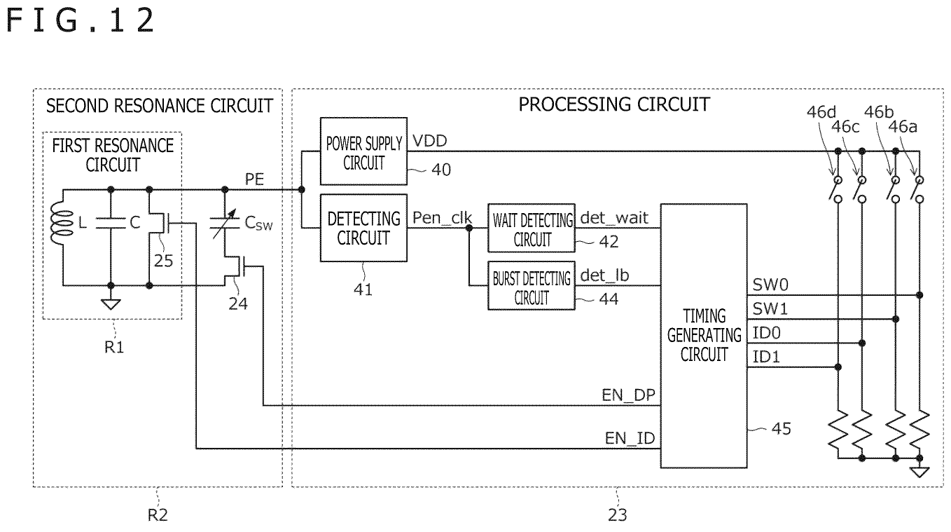

FIG. 12 is a diagram illustrating an internal configuration of the processing circuit 23 for implementing the operation described with reference to FIG. 11. As illustrated in the figure, the processing circuit 23 according to the present embodiment includes a power supply circuit 40, a detecting circuit 41, a wait detecting circuit 42, a long burst detecting circuit 44, a timing generating circuit 45, and four switch elements 46a to 46d. Of these, the power supply circuit 40, the detecting circuit 41, and the wait detecting circuit 42 are the same circuits as described in the first embodiment. In the following, the long burst detecting circuit 44, the timing generating circuit 45, and the switch elements 46a to 46d will be described in detail.

The long burst detecting circuit 44 is a circuit that generates the long burst detection signal det_Ib on the basis of the clock signal Pen_clk generated by the detecting circuit 41. The long burst detection signal det_Ib generated by the long burst detecting circuit 44 is supplied to the timing generating circuit 45 together with the wait detection signal det_wait generated by the wait detecting circuit 42.

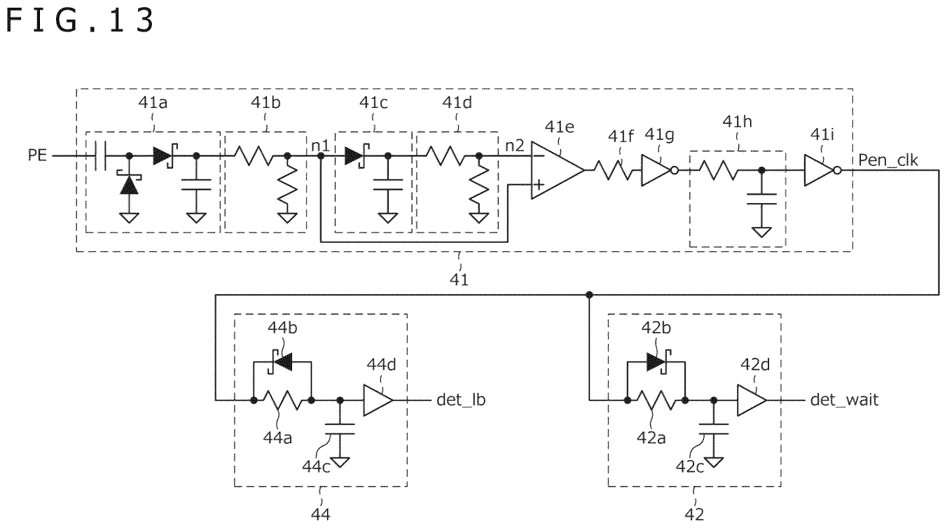

FIG. 13 is a diagram illustrating a detailed configuration of the detecting circuit 41, the wait detecting circuit 42, and the long burst detecting circuit 44. The figure is obtained by adding a configuration of the long burst detecting circuit 44 to FIG. 5.

The long burst detecting circuit 44 includes a resistive element 44a, a Schottky barrier diode 44b, a capacitor 44c, and a Schmitt trigger circuit 44d. The resistive element 44a is connected between an input node of the long burst detecting circuit 44 to which the clock signal Pen_clk is input and an input terminal of the Schmitt trigger circuit 44d. The Schottky barrier diode 44b is connected in parallel with the resistive element 44a in a direction in which a cathode thereof is connected to the input node of the long burst detecting circuit 44. The capacitor 44c is connected between the input terminal of the Schmitt trigger circuit 44d and the grounding terminal. An output terminal of the Schmitt trigger circuit 44d constitutes an output node of the long burst detecting circuit 44. A signal output from the output node of the long burst detecting circuit 44 is the long burst detection signal det_Ib described above.

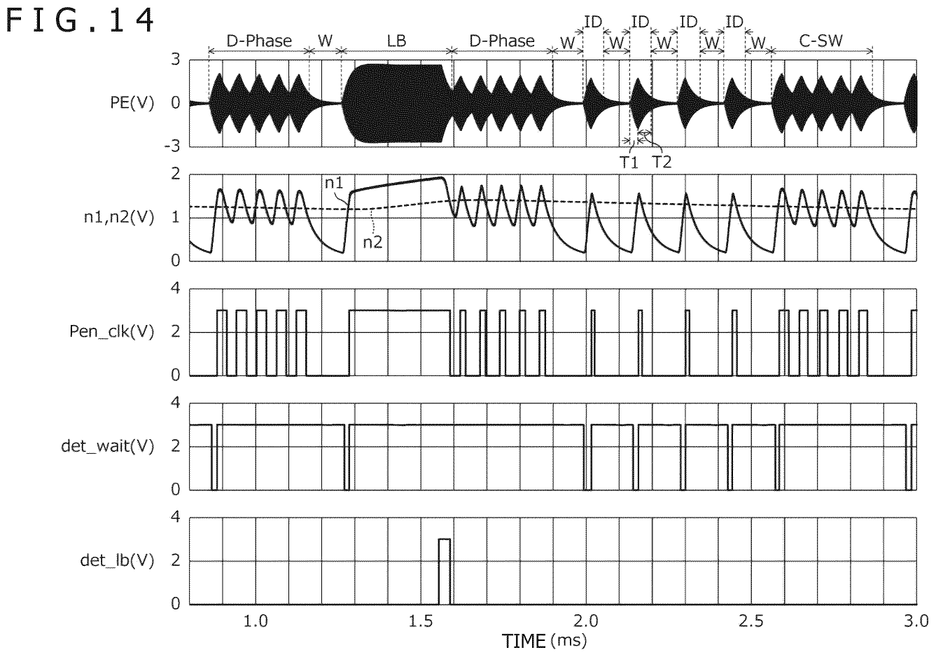

FIG. 14 is a diagram illustrating a result of simulation of the waveforms of the electromotive force PE, the output nodes n1 and n2, the clock signal Pen_clk, the wait detection signal det_wait, and the long burst detection signal det_lb. An upper part of the figure illustrates corresponding operation modes of the sensor controller 31. However, “W” denotes the operation mode Wait.

As illustrated in FIG. 14, while the sensor controller 31 is transmitting the long burst signal after entering the operation mode LB, the electromotive force PE maintains a fixed amplitude, and the clock signal Pen_clk accordingly maintains HIGH. When a period during which the clock signal Pen_clk maintains HIGH exceeds a predetermined time, the long burst detection signal det_lb changes to HIGH, as illustrated in FIG. 14, due to operation of the long burst detecting circuit 44.

Concretely describing the generation of the long burst detection signal det_Ib by the long burst detecting circuit 44 by referring to FIG. 13 again, when the clock signal Pen_clk is LOW, a current from the capacitor 44c through the Schottky barrier diode 44b to the detecting circuit 41 flows due to a discharge of the capacitor 44c. Because this discharge is performed quickly, the long burst detection signal det_Ib, which is the output of the Schmitt trigger circuit 44d, also becomes LOW at substantially the same time as the clock signal Pen_clk becomes LOW. When the clock signal Pen_clk becomes HIGH, on the other hand, a current from the detecting circuit 41 flows in through the resistive element 44a, and thereby the potential of an electrode on the detecting circuit 41 side of the capacitor 44c rises gradually. When this potential exceeds a certain value, the long burst detection signal det_Ib, which is the output of the Schmitt trigger circuit 44d, changes to HIGH. The long burst detection signal det_Ib is the above-described signal as a result of the operation of the long burst detecting circuit 44 as described above.

Returning to FIG. 14, the waveform of the electromotive force PE in a case where the sensor controller 31 has entered the operation mode ID is a waveform similar to that in a case where the sensor controller 31 has entered the operation mode D-Phase or the operation mode C-SW. That is, the electromotive force PE gradually rises and charges the capacitor C illustrated in FIG. 2 during a predetermined time T1 during which the sensor controller 31 is sending out the alternating magnetic field AM. When the predetermined time T1 has passed, sending out of the alternating magnetic field AM by the sensor controller 31 is stopped, and a discharge from the capacitor C and the variable capacitance capacitor C_{sw} is started. The sensor controller 31 is configured such that the operation mode Wait is disposed before and after the operation mode ID. Thus, as illustrated in FIG. 14, the wait detection signal det_wait is activated to be LOW before and after the operation mode ID.

The description returns to FIG. 12. The switch element 46a is a switch that is on when the side switch 22a is on and that is off when the side switch 22a is off. One terminal of the switch element 46a is supplied with the power supply voltage VDD from the power supply circuit 40. Another terminal of the switch element 46a is supplied with a ground potential via a resistive element. The potential of the other terminal of the switch element 46a (the power supply voltage VDD when the switch element 46a is on or the ground potential when the switch element 46a is off) is supplied as switch information SW 0 to the timing generating circuit 45.

Similarly, the switch element 46b is a switch that is on when the side switch 22b is on and that is off when the side switch 22b is off. One terminal of the switch element 46b is supplied with the power supply voltage VDD from the power supply circuit 40. Another terminal of the switch element 46b is supplied with the ground potential via a resistive element. The potential of the other terminal of the switch element 46b (the power supply voltage VDD when the switch element 46b is on or the ground potential when the switch element 46b is off) is supplied as switch information SW 1 to the timing generating circuit 45.

In addition, the switch element 46c is a switch that is on when the first bit of the identification information of the electromagnetic induction pen 2 is “1” and that is off when the first bit of the identification information of the electromagnetic induction pen 2 is “0.” One terminal of the switch element 46c is supplied with the power supply voltage VDD from the power supply circuit 40. Another terminal of the switch element 46c is supplied with the ground potential via a resistive element. The potential of the other terminal of the switch element 46c (the power supply voltage VDD when the switch element 46c is on or the ground potential when the switch element 46c is off) is supplied as identification information ID0 to the timing generating circuit 45.

Similarly, the switch element 46d is a switch that is on when the second bit of the identification information of the electromagnetic induction pen 2 is “1” and that is off when the second bit of the identification information of the electromagnetic induction pen 2 is “0.” One terminal of the switch element 46d is supplied with the power supply voltage VDD from the power supply circuit 40. Another terminal of the switch element 46d is supplied with the ground potential via a resistive element. The potential of the other terminal of the switch element 46d (the power supply voltage VDD when the switch element 46d is on or the ground potential when the switch element 46d is off) is supplied as identification information ID1 to the timing generating circuit 45.

The timing generating circuit 45 is a circuit that receives the input of the wait detection signal det_wait, the long burst detection signal det_Ib, the switch information SWO and SW 1, and the identification information ID0 and ID1, and generates the D-Phase enable signal EN_DP and the digital data transmission enable signal EN_ID. The three-bit counter cnt_s, the D-Phase detection signal det_dp, the digital data transmission period detection signal det_id, the first side switch selection signal sel_sw0, the second side switch selection signal sel_sw1, the first identification information selection signal sel_id0, and the second identification information selection signal sel_id1 illustrated in FIG. 11 are generated or used within the timing generating circuit 45.

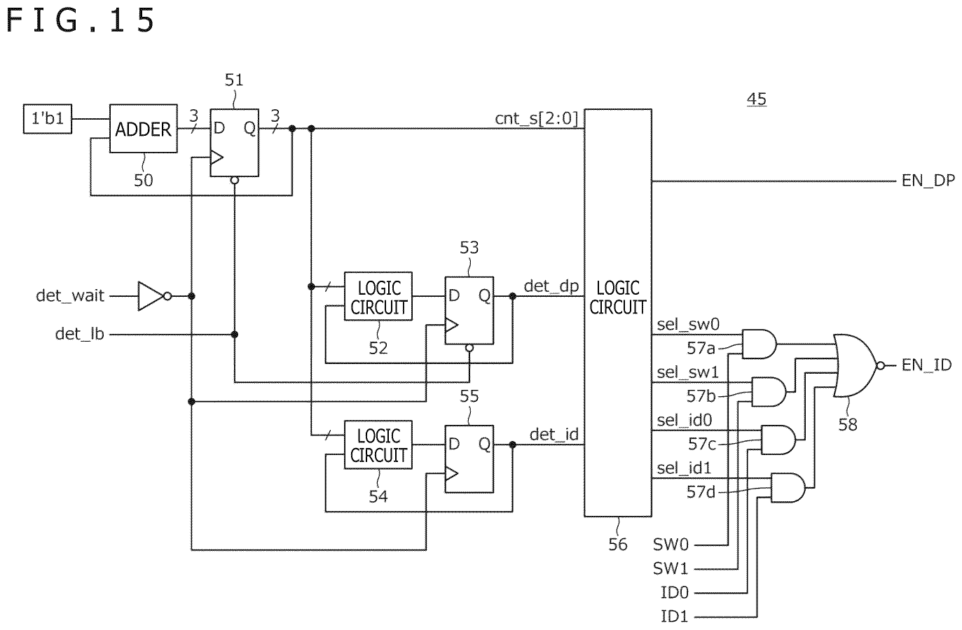

FIG. 15 is a diagram illustrating an internal configuration of the timing generating circuit 45. As illustrated in the figure, the timing generating circuit 45 includes an adder 50, D-type flip-flop circuits 51, 53, and 55, logic circuits 52, 54, and 56, AND circuits 57a to 57d, and an OR circuit 58.

The flip-flop circuit 51 is a circuit that outputs a value supplied to a data terminal thereof from an output terminal thereof in a timing in which a clock terminal thereof is activated. The data terminal of the flip-flop circuit 51 is supplied with a three-bit value from the adder 50. The output value of the flip-flop circuit 51 is supplied as the three-bit counter cnt_s illustrated in FIG. 11 to the logic circuit 56.

The adder 50 is a circuit that supplies the data terminal of the flip-flop circuit 51 with a three-bit value obtained by adding one to the three-bit counter cnt_s output from the flip-flop circuit 51. However, the adder 50 is configured to supply four to the data terminal of the flip-flop circuit 51 when an addition result becomes five. The output value of the adder 50 is thereby suppressed to an integer value of four or less.

The clock terminal of the flip-flop circuit 51 is supplied with the inverted signal of the wait detection signal det_wait. Thus, the three-bit counter cnt_s, which is the output value of the flip-flop circuit 51, is incremented by one each time the wait detection signal det_wait is activated to be LOW. However, because the output value of the adder 50 is suppressed to an integer value of four or less as described above, the three-bit counter cnt_s is also four at a maximum. In addition, a reset terminal of the flip-flop circuit 51 is supplied with an inverted signal of the long burst detection signal det_lb. Thus, when the long burst detection signal det_Ib becomes HIGH, the three-bit counter cnt_s is reset to zero.

As with the flip-flop circuit 51, the flip-flop circuit 53 is a circuit that outputs a value supplied to a data terminal thereof from an output terminal thereof in a timing in which a clock terminal thereof is activated. The data terminal of the flip-flop circuit 53 is supplied with a one-bit value from the logic circuit 52. The output value of the flip-flop circuit 53 is supplied as the D-Phase detection signal det_dp illustrated in FIG. 11 to the logic circuit 56.

The logic circuit 52 is a circuit that inverts the output value (0 or 1) of the flip-flop circuit 53 and supplies the inverted output value to the data terminal of the flip-flop circuit 53 only when the value of the three-bit counter cnt_s is four. In addition, as in the flip-flop circuit 51, the clock terminal of the flip-flop circuit 53 is supplied with the inverted signal of the wait detection signal det_wait. Hence, the value of the D-Phase detection signal det_dp is inverted between zero and one each time the wait detection signal det_wait is activated to be LOW only when the value of the three-bit counter cnt_s is four.

In addition, as in the flip-flop circuit 51, a reset terminal of the flip-flop circuit 53 is supplied with the inverted signal of the long burst detection signal det_lb. Thus, the value of the D-Phase detection signal det_dp is reset to one in response to the long burst detection signal det_Ib becoming HIGH.

As with the flip-flop circuits 51 and 53, the flip-flop circuit 55 is a circuit that outputs a value supplied to a data terminal thereof from an output terminal thereof in a timing in which a clock terminal thereof is activated. The data terminal of the flip-flop circuit 55 is supplied with one-bit value from the logic circuit 54. The output value of the flip-flop circuit 55 is supplied as the digital data transmission period detection signal det_id illustrated in FIG. 11 to the logic circuit 56.

The logic circuit 54 is a circuit that inverts the output value (0 or 1) of the flip-flop circuit 53 and supplies the inverted output value to the data terminal of the flip-flop circuit 53 when the value of the three-bit counter cnt_s is zero and that supplies zero to the data terminal of the flip-flop circuit 53 when the three-bit counter cnt_s is four. In addition, as in the flip-flop circuits 51 and 53, the clock terminal of the flip-flop circuit 55 is supplied with the inverted signal of the wait detection signal det_wait. Hence, the value of the digital data transmission period detection signal det_id becomes one in response to changing of the wait detection signal det_wait to LOW when the value of the three-bit counter cnt_s is zero, and the value of the digital data transmission period detection signal det_id becomes zero in response to changing of the wait detection signal det_wait to LOW when the value of the three-bit counter cnt_s is four.

The logic circuit 56 is a circuit that generates the D-Phase enable signal EN_DP, the first side switch selection signal sel_sw0, the second side switch selection signal sw1, the first identification information selection signal sel_id0, and the second identification information selection signal sel_id1 on the basis of the respective values of the three-bit counter cnt_s, the D-Phase detection signal det_dp, and the digital data transmission period detection signal det_id. Specifically, the logic circuit 56 is configured to generate the D-Phase enable signal EN_DP by setting the inverted signal of the D-Phase detection signal det_dp as the D-Phase enable signal EN_DP when the digital data transmission period detection signal det_id is LOW, and fixing the D-Phase enable signal EN_DP to HIGH when the digital data transmission period detection signal det_id is HIGH.

Here, the generation of the D-Phase enable signal EN_DP when the digital data transmission period detection signal det_id is LOW is the same as the operation of the toggle circuit 43 illustrated in FIG. 4 except that the D-Phase detection signal det_dp is interposed. Hence, the timing generating circuit 45 can be said to include the toggle circuit 43.

In addition, the logic circuit 56 performs processing of activating the first side switch selection signal sel_sw0 to HIGH over a predetermined time in response to changing of the value of the three-bit counter cnt_s to one, activating the second side switch selection signal sel_sw1 to HIGH over a predetermined time in response to changing of the value of the three-bit counter cnt_s to two, activating the first identification information selection signal sel_id0 to HIGH over a predetermined time in response to changing of the value of the three-bit counter cnt_s to three, and activating the second identification information selection signal sel_id1 to HIGH over a predetermined time in response to changing of the value of the three-bit counter cnt_s to four.

The AND circuit 57a is a circuit that outputs HIGH when both the first side switch selection signal sel_sw0 and the switch information SWO illustrated in FIG. 12 are HIGH and that otherwise outputs LOW. The AND circuit 57b is a circuit that outputs HIGH when both the second side switch selection signal sel_sw1 and the switch information SW 1 illustrated in FIG. 12 are HIGH and that otherwise outputs LOW. The AND circuit 57c is a circuit that outputs HIGH when both the first identification information selection signal sel_id0 and the identification information ID0 illustrated in FIG. 12 are HIGH and that otherwise outputs LOW. The AND circuit 57d is a circuit that outputs HIGH when both the second identification information selection signal sel_id1 and the identification information ID1 illustrated in FIG. 12 are HIGH and that otherwise outputs LOW.

The OR circuit 58 is a circuit that outputs LOW when each of the outputs of the four AND circuits 57a to 57d is LOW and that otherwise outputs HIGH. The digital data transmission enable signal EN_ID described above is an inverted signal of the output of the OR circuit 58. Thus, the digital data transmission enable signal EN_ID is LOW when a bit value to be transmitted is “1,” and the digital data transmission enable signal EN_ID is HIGH when the bit value to be transmitted is “0.” The control of the switch element 25 described above (turning off the switch element 25 in a case of transmission of “1,” and turning on the switch element 25 in a case of transmission of “0”) is therefore realized.

FIG. 16 and FIG. 17 are a flowchart illustrating processing performed by the sensor controller 31 according to the present embodiment. In the following, operation of the sensor controller 31 according to the present embodiment will be described in more detail with reference to these drawings.

First referring to FIG. 16, the sensor controller 31 first enters the operation mode LB (step S30), and sends out the long burst signal (step S31). Consequently, the order of sending out the reference alternating magnetic field PSS and the modulated alternating magnetic field PSM by the electromagnetic induction pen 2 is reset, and the alternating magnetic field PS to be transmitted next by the electromagnetic induction pen 2 is always the reference alternating magnetic field PSS. Accordingly, the sensor controller 31 next enters the operation mode D-Phase (step S32), and performs the supply of the alternating current Tx to each loop coil L Cy and the detection of the amplitude of the induced current Rx appearing in each loop coil LCx (step S33).

Next, the sensor controller 31 derives the position of the electromagnetic induction pen 2 on the basis of the amplitude of the induced current Rx in each loop coil LCy, which is detected in step S33, and outputs the position of the electromagnetic induction pen 2 to the host processor 32 (step S34). In addition, the sensor controller 31 derives the phase of the induced current Rx in a loop coil L Cx whose amplitude detected in step S33 is largest, and stores the phase of the induced current Rx as the reference phase (step S35).

Next, the sensor controller 31 determines whether or not a present time is a reception timing of the digital data from the electromagnetic induction pen 2 (step S36). A result of this determination is affirmative immediately after the long burst signal is transmitted in step S31 (that is, after the operation mode D-Phase is executed only once after the transmission of the long burst signal). The determination result is negative at other time points. Obtaining an affirmative determination result in step S36, the sensor controller 31 performs digital data reception processing for receiving the digital data transmitted by the electromagnetic induction pen 2 (step S37).

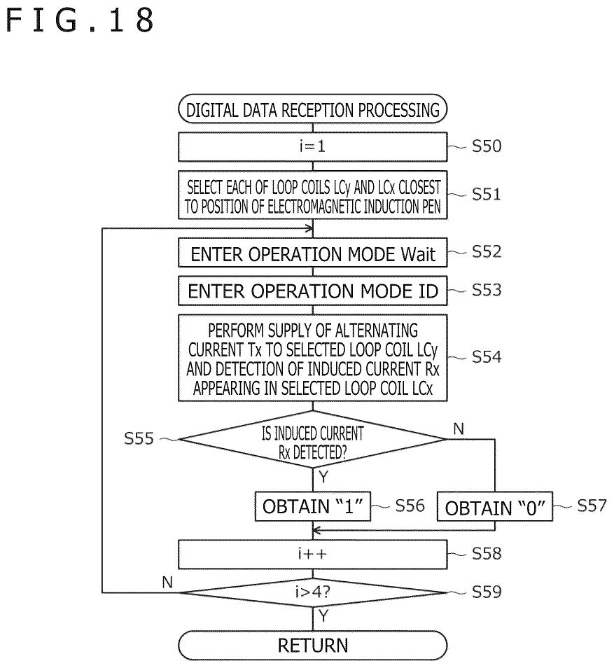

FIG. 18 is a diagram illustrating details of the digital data reception processing performed in step S37 in FIG. 16. As illustrated in the figure, the sensor controller 31 first assigns one to a variable i (step S50), and further selects one loop coil LCy and one loop coil L Cx closest to the position of the electromagnetic induction pen 2 derived in immediately preceding step S34 (see FIG. 16) from among the plurality of loop coils LCy and the plurality of loop coils L Cx, respectively (step S51).

Next, after waiting for a predetermined time by entering the operation mode Wait (step S52), the sensor controller 31 enters the operation mode ID (step S53), and performs the supply of the alternating current Tx to the loop coil LCy selected in step S51 and the detection of the induced current Rx appearing in the loop coil L Cx selected in step S51 (step S54). Then, the sensor controller 31 demodulates an ith bit value sent out by the electromagnetic induction pen 2 on the basis of a result of the detection of the induced current Rx (steps S55 to S57). Specifically, the sensor controller 31 determines whether or not the induced current Rx is detected in step S44 (step S55). The sensor controller 31 obtains “1” when determining that the induced current Rx is detected (step S56). The sensor controller 31 obtains “0” when determining that the induced current Rx is not detected (step S57).

Thereafter, the sensor controller 31 increments the variable i by one (step S58), and determines whether or not the variable i has exceeded four (step S59). When the variable i does not exceed four as a result, the sensor controller 31 returns to step S52 to repeat the processing. When the variable i exceeds four, the sensor controller 31 ends the digital data reception processing. By the above processing, the sensor controller 31 receives the four bits of digital data transmitted by the electromagnetic induction pen 2.

The description returns to FIG. 16. Completing the digital data reception processing in step S37 or obtaining a negative determination result in step S36, the sensor controller 31 waits for a predetermined time by entering the operation mode Wait (step S38), and thereafter determines whether or not a predetermined time has passed since the transmission of a previous long burst signal (step S39). When determining, as a result, that the predetermined time has passed, the sensor controller 31 returns to step S30 to enter the operation mode LB again. When determining that the predetermined time has not passed, the sensor controller 31 shifts the processing to step S40 in FIG. 17.

Moving to FIG. 17, the sensor controller 31 in step S40 enters the operation mode C-SW. Then, as in step S33 in FIG. 16, the sensor controller 31 performs the supply of the alternating current Tx to each loop coil LCy and the detection of the amplitude of the induced current Rx appearing in each loop coil LCx (step S41).

Next, the sensor controller 31 derives the position of the electromagnetic induction pen 2 on the basis of the amplitude of the induced current Rx in each loop coil L Cy, which is detected in step S41, and outputs the position of the electromagnetic induction pen 2 to the host processor 32 (step S42). In addition, the sensor controller 31 derives the phase of the induced current Rx in a loop coil LCx whose amplitude detected in step S41 is largest (step S43). Then, the sensor controller 31 derives the pen pressure value P transmitted by the electromagnetic induction pen 2 on the basis of the derived phase and the reference phase stored in immediately preceding step S35, and outputs the pen pressure value P to the host processor 32 (step S44). A concrete method of deriving the pen pressure value P is as described in the first embodiment.

Then, the sensor controller 31 waits for a predetermined time by entering the operation mode Wait (step S45), and thereafter determines whether or not a predetermined time has passed since the transmission of a previous long burst signal (step S46). When determining, as a result, that the predetermined time has passed, the sensor controller 31 returns to step S30 to enter the operation mode LB again. When determining that the predetermined time has not passed, the sensor controller 31 returns to step S32 to enter the operation mode D-Phase again.

As described above, according to the position detection system 1 in accordance with the present embodiment, while the accuracy of detection of the value indicating the behavior of the user, including the pen pressure value P, is improved more than conventional by alternately sending out the reference alternating magnetic field and the modulated alternating magnetic field from the electromagnetic induction pen 2 as in the first embodiment, digital data can be further transmitted from the electromagnetic induction pen 2 to the position detecting device 3.

In addition, according to the position detection system 1 in accordance with the present embodiment, the order of sending out the reference alternating magnetic field PSS and the modulated alternating magnetic field PSM by the electromagnetic induction pen 2 can be reset from the sensor controller 31. Thus, the sensor controller 31 does not need to execute the initial setting mode described in the first embodiment, and can start the derivation of the pen pressure value P at a correspondingly early stage.

In addition, according to the position detection system 1 in accordance with the present embodiment, both the digital data (the switch information SWO and SW 1 and the identification information ID0 and ID1) and the analog operation amount (pen pressure value P) are transmitted in a period in which the sensor controller 31 is not sending out the alternating magnetic field AM. It is therefore possible to prevent the position detecting device 3 from failing in detecting the analog operation amount transmitted by the electromagnetic induction pen 2 and receiving the digital data.

A position detection system 1 according to a third embodiment of the present disclosure will next be described. The position detection system 1 according to the present embodiment is different from the position detection system 1 according to the second embodiment in that one-bit digital data is transmitted by the kind of the alternating magnetic field PS being sent out (the reference alternating magnetic field PSS or the modulated alternating magnetic field PSM) rather than whether or not the electromagnetic induction pen 2 is sending out the alternating magnetic field PS. The position detection system 1 according to the present embodiment is otherwise similar to the position detection system 1 according to the second embodiment. Thus, in the following, the description will be continued with attention directed to differences from the position detection system 1 according to the second embodiment.

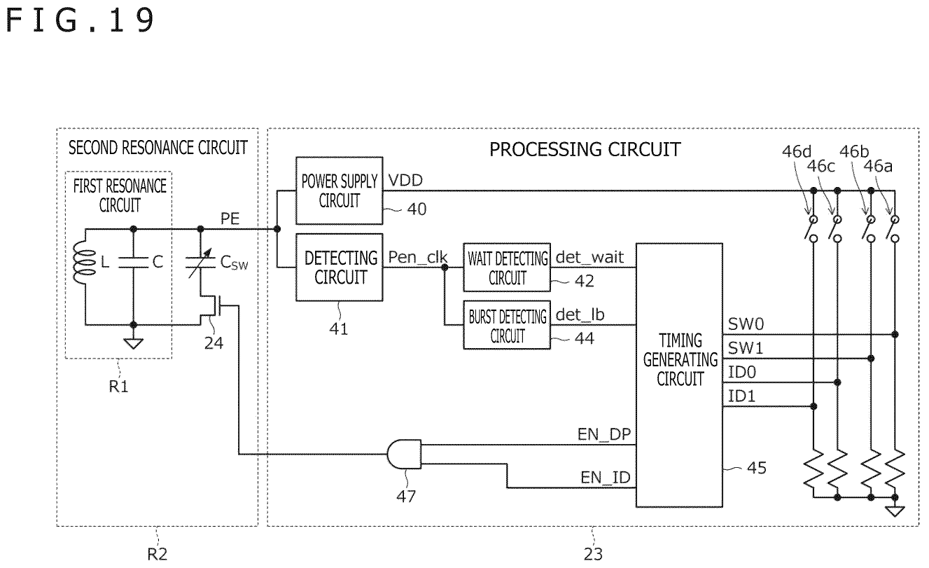

FIG. 19 is a diagram illustrating an internal configuration of the electromagnetic induction pen 2 of the position detection system 1 according to the present embodiment. As is understood by comparing the figure with FIG. 12, the electromagnetic induction pen 2 according to the present embodiment is different from the electromagnetic induction pen 2 according to the second embodiment in that an AND circuit 47 is provided within the processing circuit 23 and in that the first resonance circuit R1 does not have the switch element 25.

The AND circuit 47 is a circuit that outputs HIGH when both the D-Phase enable signal EN_DP and the digital data transmission enable signal EN_ID output from the timing generating circuit 45 are HIGH and that otherwise outputs LOW. The output of the AND circuit 47 is supplied to the gate of the switch element 24. Here, as illustrated in FIG. 11, the D-Phase enable signal EN_DP during the transmission of the digital data from the electromagnetic induction pen 2 is fixed to HIGH. In addition, as is understood from FIG. 15, the digital data transmission enable signal EN_ID in a case where no digital data is transmitted from the electromagnetic induction pen 2 is fixed to HIGH. Hence, according to the AND circuit 47, the value of the digital data transmission enable signal EN_ID is supplied to the gate of the switch element 24 when digital data is to be transmitted from the electromagnetic induction pen 2. Thus, the reference alternating magnetic field PSS is sent out when a bit value to be transmitted is “1” (that is, when the digital data transmission enable signal EN_ID is LOW), and the modulated alternating magnetic field PSM is sent out when the bit value to be transmitted is “0” (that is, when the digital data transmission enable signal EN_ID is HIGH). In addition, according to the AND circuit 47, one of the reference alternating magnetic field PSS and the modulated alternating magnetic field PSM is sent out according to the D-Phase enable signal EN_DP when no digital data is transmitted from the electromagnetic induction pen 2.

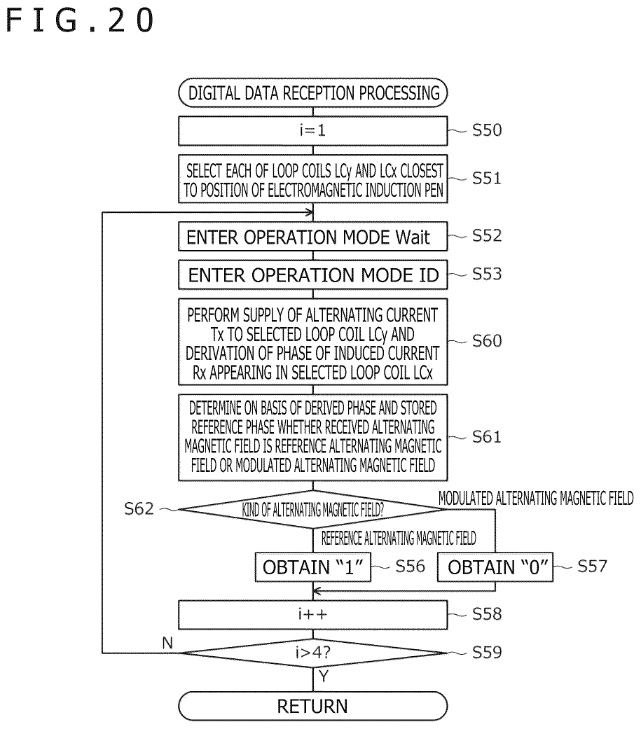

FIG. 20 is a flowchart illustrating digital data reception processing performed by the sensor controller 31 according to the present embodiment. As is understood by comparing the figure with FIG. 18, the digital data reception processing performed by the sensor controller 31 according to the present embodiment is different from the digital data reception processing performed by the sensor controller 31 according to the second embodiment in that steps S60 to S62 are performed in place of steps S54 and S55. In the following, description will be made with attention directed to differences.

After entering the operation mode ID in step S53, the sensor controller 31 according to the present embodiment performs the supply of the alternating current Tx to the loop coil LCy selected in step S51 and the derivation of the phase of the induced current Rx appearing in the loop coil L Cx selected in step S51 (step S60). Then, the sensor controller 31 demodulates an ith bit value sent out by the electromagnetic induction pen 2 on the basis of the derived phase and the reference phase stored in immediately preceding step S35 (see FIG. 16) (steps S61, S62, S56, and S57). Specifically, the sensor controller 31 determines whether a received alternating magnetic field PS is one of the reference alternating magnetic field PSS and the modulated alternating magnetic field PSM on the basis of the derived phase and the stored reference phase (steps S61 and S62). The sensor controller 31 obtains “1” when determining that the received alternating magnetic field PS is the reference alternating magnetic field PSS (step S56). The sensor controller 31 obtains “0” when determining that the received alternating magnetic field PS is the modulated alternating magnetic field PSM (step S57). The sensor controller 31 can thereby receive the bit value transmitted by the electromagnetic induction pen 2.

As described above, according to the position detection system 1 in accordance with the present embodiment, the electromagnetic induction pen 2 can transmit digital data by switching between sending out of the reference alternating magnetic field PSS and sending out of the modulated alternating magnetic field PSM. Hence, it is possible to maintain a state of sending out the alternating magnetic field PS from the electromagnetic induction pen 2 even when transmitting the digital data.

A position detection system 1 according to a fourth embodiment of the present disclosure will next be described. The position detection system 1 according to the present embodiment is different from the position detection system 1 according to the second embodiment in that the electromagnetic induction pen 2 is configured to transmit the digital data including the switch information SW 0 and SW 1 and the identification information ID0 and ID1 continuously irrespective of whether or not the long burst signal is received. The position detection system 1 according to the present embodiment is otherwise similar to the position detection system 1 according to the second embodiment. Thus, in the following, the description will be continued with attention directed to differences from the position detection system 1 according to the second embodiment.

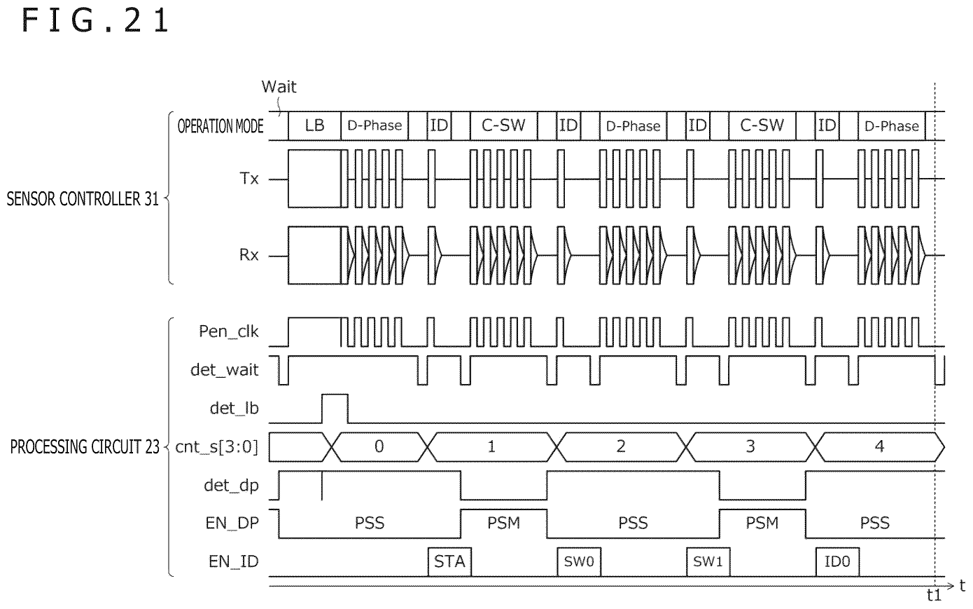

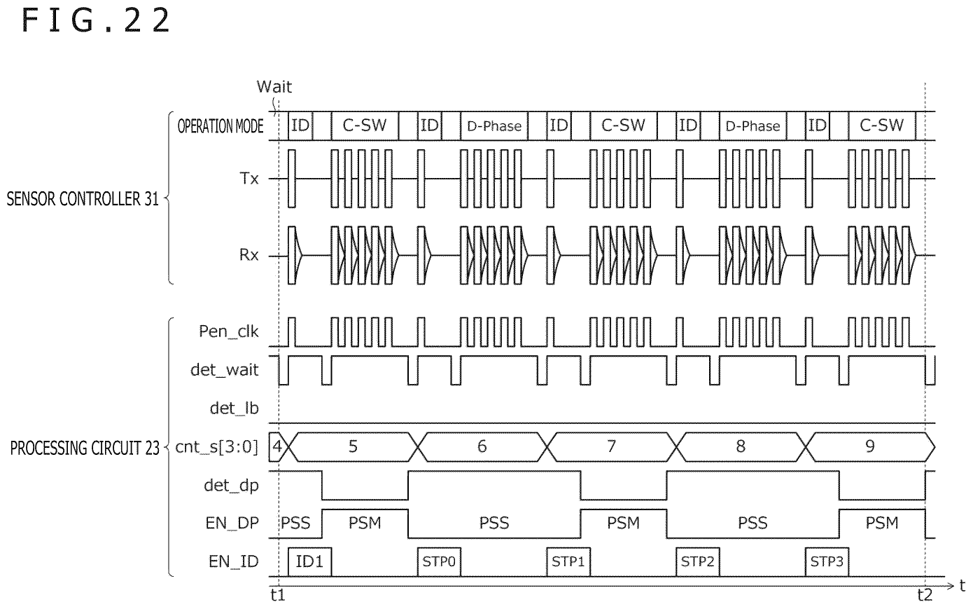

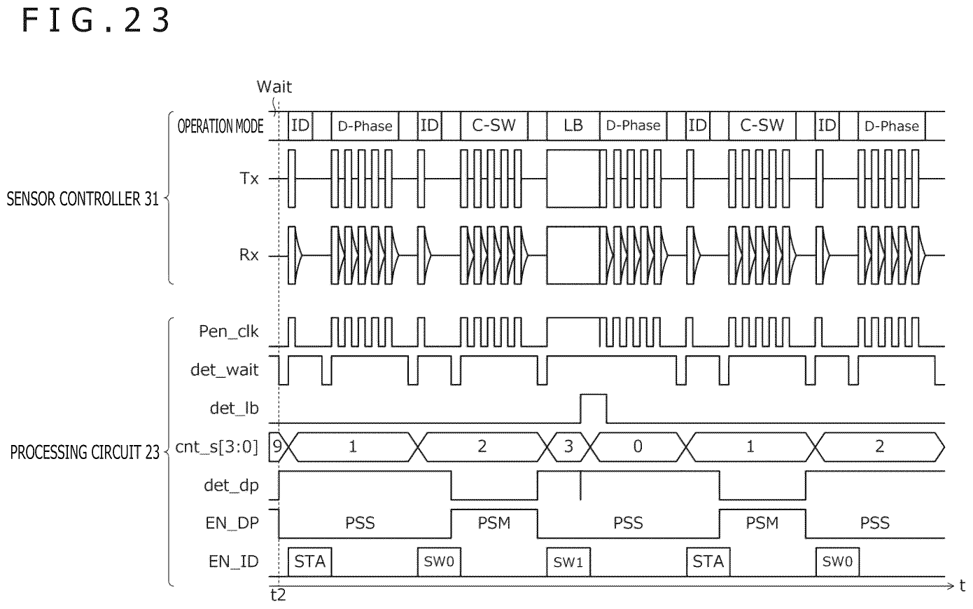

FIGS. 21 to 23 are diagrams of assistance in explaining operation of the sensor controller 31 and the processing circuit 23 according to the present embodiment. FIG. 22 illustrates a continuation of FIG. 21. FIG. 23 illustrates a continuation of FIG. 22. As illustrated in these figures, the sensor controller 31 according to the present embodiment is configured to perform operation of entering the operation mode Wait, the operation mode ID, the operation mode Wait, the operation mode C-SW, the operation mode Wait, the operation mode ID, the operation mode Wait, and the operation mode D-Phase in this order after entering the operation mode LB and the following operation mode D-Phase, and repeat the same operation until next entering the operation mode LB (for example, until a predetermined time has passed since the transmission of a previous long burst signal). While FIGS. 21 to 23 illustrate an example of entering the operation mode LB again after executing each of the operation modes D-Phase and C-SW six times from the first operation mode LB, this is a mere example for illustrating operation at a time of entering the next operation mode LB. It suffices for an actual sensor controller 31 to enter the operation mode LB at a lower frequency.

An internal configuration of the processing circuit 23 is similar to that illustrated in FIG. 12. However, there are parts different from those of the second embodiment in the configuration and operation of the timing generating circuit 45. Specifically, first, the timing generating circuit 45 according to the present embodiment includes a four-bit counter cnt_s in place of the three-bit counter cnt_s. The timing generating circuit 45 is configured to reset the value of the four-bit counter cnt_s to zero in response to the long burst detection signal det_Ib becoming HIGH, and thereafter increment the value of the four-bit counter cnt_s by one in a timing in which the wait detection signal det_wait becomes LOW for an odd-numbered time counted from a timing in which the long burst detection signal det_Ib becomes HIGH. This increment is continued until the value of the four-bit counter cnt_s becomes nine. After the value of the four-bit counter cnt_s becomes nine, the value of the four-bit counter cnt_s is temporarily returned to one, and similar increment is continued again.

In addition, the timing generating circuit 45 according to the present embodiment is configured to change the value of the D-Phase detection signal det_dp to LOW in response to the long burst detection signal det_Ib becoming HIGH, and thereafter switch the value of the D-Phase detection signal det_dp between HIGH and LOW in a timing in which the wait detection signal det_wait becomes LOW for a (4n+2)th time and a (4n+3)th time (n is an integer of zero or more) counted from a timing in which the long burst detection signal det_Ib becomes HIGH. As for the D-Phase enable signal EN_DP generated from the D-Phase detection signal det_dp, the timing generating circuit 45 according to the present embodiment is configured to always set the inverted signal of the D-Phase detection signal det_dp as the D-Phase enable signal EN_DP. Consequently, the alternating magnetic field transmitted by the electromagnetic induction pen 2 is the modulated alternating magnetic field PSM when the sensor controller 31 has entered the operation mode C-SW, and the alternating magnetic field is the reference alternating magnetic field PSS when the sensor controller 31 has entered the operation mode D-Phase or the operation mode ID.

The digital data transmitted by the electromagnetic induction pen 2 according to the present embodiment includes not only the switch information SWO and SW 1 and the identification information ID0 and ID1 described above but also one-bit start data STA and four-bit stop data STPO to STP3. The timing generating circuit 45 controls the digital data transmission enable signal EN_ID such that a value of these nine bits in total is transmitted on a bit-by-bit basis in a timing corresponding to the value of the four-bit counter cnt_s. Specifically, the timing generating circuit 45 is configured to sequentially control the digital data transmission enable signal EN_ID on the basis of the start data STA, the switch information SW 0 and SW 1, the identification information ID0 and ID1, and the stop data ST PO to STP3 in response to changing of the value of the four-bit counter cnt_s to one to nine. The sensor controller 31 thereby sequentially receives the start data STA, the switch information SW 0 and SW 1, the identification information ID0 and ID1, and the stop data ST PO to STP3 each time the sensor controller 31 enters the operation mode ID after transmitting the long burst signal. The start data STA and the stop data STPO to STP3 in this case are used to determine a start and an end of the data received by the sensor controller 31.

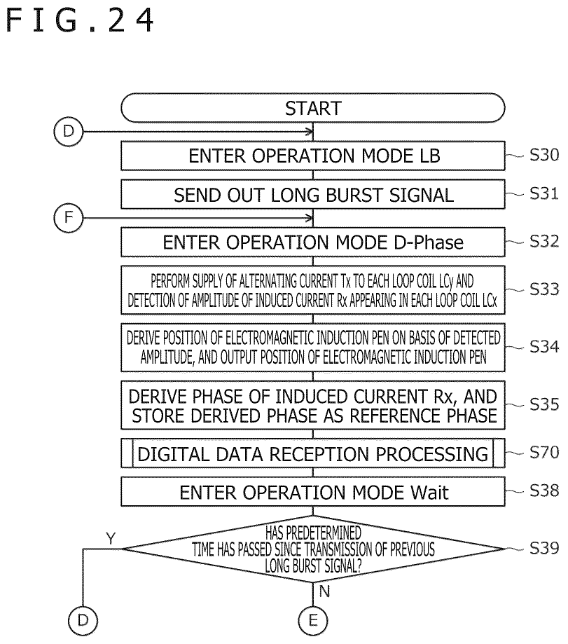

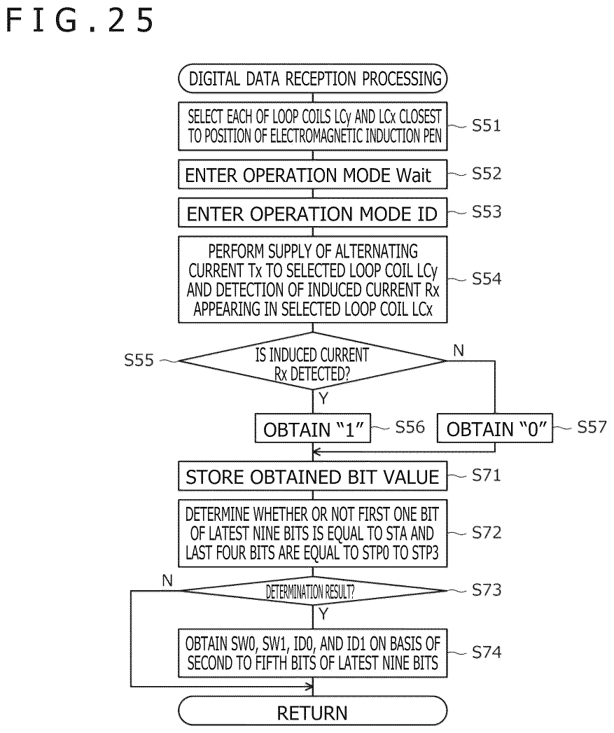

FIG. 24 and FIG. 25 are a flowchart illustrating processing performed by the sensor controller 31 according to the present embodiment. These figures are obtained by modifying FIG. 16 and FIG. 18. Parts in which the same processing as in FIG. 16 and FIG. 18 is performed are identified by the same reference numerals as in FIG. 16 and FIG. 18. In the following, operation of the sensor controller 31 according to the present embodiment will be described in more detail with reference to FIG. 24 and FIG. 25.

First referring to FIG. 24, the sensor controller 31 makes the processing of steps S30 to S35 progress as in the example of FIG. 16, and thereafter performs digital data reception processing for receiving digital data transmitted by the electromagnetic induction pen 2 (step S70).

FIG. 25 illustrates details of the digital data reception processing performed in step S70 in FIG. 24. As illustrated in the figure, the sensor controller 31 according to the present embodiment makes the processing of steps S51 to S57 progress as in the example of FIG. 18, and thereafter stores the bit value obtained in step S56 or step S57 (step S71). Then, the sensor controller 31 determines whether or not the first one bit of the latest nine bits is equal to the start data STA and whether or not the last four bits thereof are equal to the stop data ST PO to STP3 (steps S72 and S73).

When determining, in step S73, that the first one bit of the latest nine bits is equal to the start data STA and that the last four bits thereof are equal to the stop data STPO to STP3, the sensor controller 31 obtains the switch information SWO and SW 1 and the identification information ID0 and ID1 on the basis of the second to fifth bits of the latest nine bits (step S74), and then ends the digital data reception processing. When the sensor controller 31 does not determine in step S73 that the first one bit of the latest nine bits is equal to the start data STA and that the last four bits thereof are equal to the stop data STPO to STP3, the sensor controller 31 ends the digital data reception processing without performing step S74.

The description returns to FIG. 24. Ending the digital data reception processing in step S70, the sensor controller 31 performs the processing from step S38 and the subsequent steps as in the example of FIG. 16 and FIG. 17. This realizes alternately entering the operation mode D-Phase and the operation mode C-SW while the operation mode ID is interposed and entering the operation mode LB again when a predetermined time has passed since the transmission of a previous long burst signal.

The position detection system 1 according to the present embodiment provides an effect of being able to greatly reduce the transmission frequency of the long burst signal as compared with the position detection system 1 according to the second embodiment. That is, in the position detection system 1 according to the present embodiment, the electromagnetic induction pen 2 repeatedly transmits nine bits of information including the switch information SWO and SW 1 and the identification information ID0 and ID1 irrespective of whether or not the long burst signal is received. Thus, the sensor controller 31 can continually receive the switch information SWO and SW 1 and the identification information ID0 and ID1 from the electromagnetic induction pen 2 even when the sensor controller 31 does not generate a trigger of the long burst signal. Hence, the sensor controller 31 according to the present embodiment does not need to transmit the long burst signal in order to make the electromagnetic induction pen 2 transmit the switch information SW 0 and SW 1 and the identification information ID0 and ID1. It is therefore possible to greatly reduce the transmission frequency of the long burst signal. In an example, it suffices for the sensor controller 31 to transmit the long burst signal for a purpose of initializing the transmission order of the reference alternating magnetic field PSS and the modulated alternating magnetic field PSM only when detecting the electromagnetic induction pen 2 anew.

A position detection system 1 according to a fifth embodiment of the present disclosure will next be described. The position detection system 1 according to the present embodiment is different from the position detection system 1 according to the second embodiment in that the electromagnetic induction pen 2 is configured to transmit a plurality of bits of digital data at the same time by frequency shift keying. The position detection system 1 according to the present embodiment is otherwise similar to the position detection system 1 according to the second embodiment. Thus, in the following, the description will be continued with attention directed to differences from the position detection system 1 according to the second embodiment.

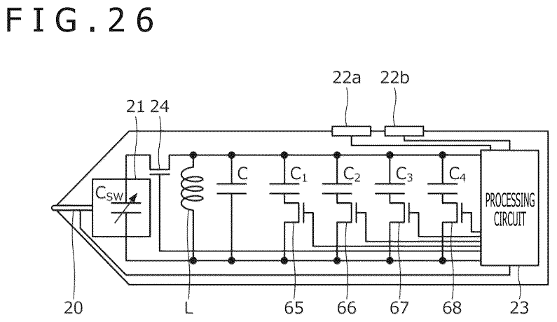

FIG. 26 is a diagram illustrating a configuration of the electromagnetic induction pen 2 according to the present embodiment. As is understood by comparing the figure with FIG. 10, the electromagnetic induction pen 2 according to the present embodiment is different from the electromagnetic induction pen 2 according to the second embodiment in that the electromagnetic induction pen 2 according to the present embodiment includes capacitors C₁ to C₄ and switch elements 65 to 68 in place of the switch element 25.

The capacitors C₁ to C₄ are each connected in parallel with the capacitor C. In addition, the switch elements 65 to 68 are respectively connected in series with the capacitors C₁ to C₄. The electromagnetic induction pen 2 according to the present embodiment is configured to turn off the switch element 24 and turn on the switch elements 65 to 68 when sending out the reference alternating magnetic field PSS. Thus, in the present embodiment, the frequency of the reference alternating magnetic field PSS (reference frequency) is a value determined by a combined capacitance of the capacitors C and C₁ to C₄ (frequency f₀ to be described later). In addition, the electromagnetic induction pen 2 is configured to turn on all of the switch elements 24 and 65 to 68 when sending out the modulated alternating magnetic field PSM. Thus, in the present embodiment, the frequency of the modulated alternating magnetic field PSM is a value determined by a combined capacitance of the capacitors C, C_{sw}, and C₁ to C₄ (frequency fsw to be described later).

On the other hand, the electromagnetic induction pen 2 according to the present embodiment is configured to turn off the switch element 24 and control on/off states of the switch elements 65 to 68 according to a transmission value when transmitting the digital data. As a result, the frequency of the alternating magnetic field sent out from the electromagnetic induction pen 2 is a value determined by a combined capacitance of the capacitor C and capacitors connected to the capacitor C among the capacitors C₁ to C₄ (frequencies f₀ to f₁₅ to be described later). The electromagnetic induction pen 2 according to the present embodiment is configured to transmit the four-bit digital data by utilizing characteristics of the frequency of such an alternating magnetic field.

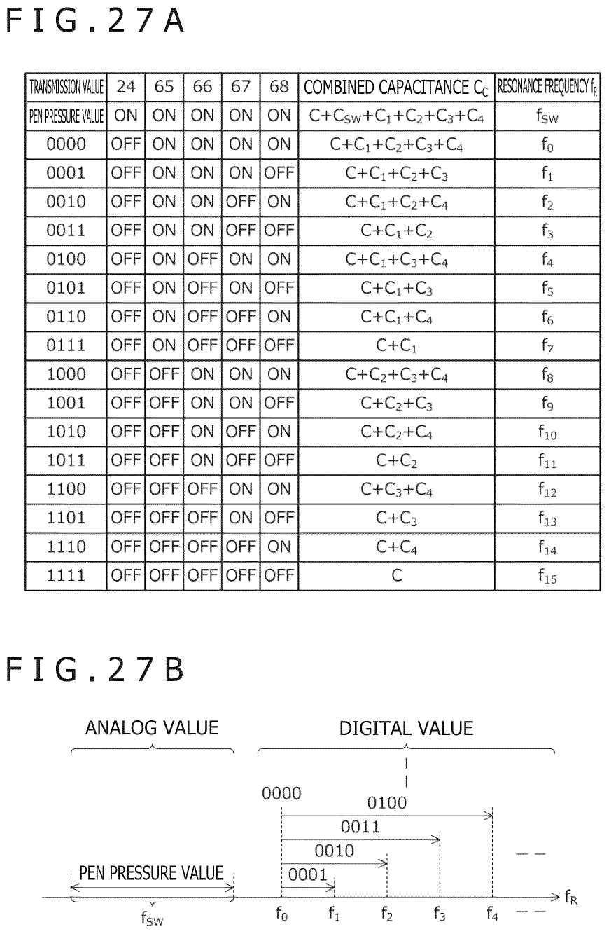

FIG. 27A is a diagram illustrating a relation between values transmitted by the electromagnetic induction pen 2 (including the pen pressure value P as an analog operation amount), the on/off states of the switch elements 24 and 65 to 68, a combined capacitance Cc of capacitors incorporated in the resonance circuit among the capacitors C, C_{sw}, and C₁ to C₄, and a resonance frequency f_{R} of the resonance circuit. In the figure and in the following description, the capacitances of the capacitors C, C_{sw}, and C₁ to C₄ are respectively denoted as C, C_{sw}, and C₁ to C₄, and the inductance of the coil L is denoted as L.

As illustrated in FIG. 27A, the value of the combined capacitance Cc in a case where the electromagnetic induction pen 2 transmits the pen pressure value P is C+C_{sw}+C₁+C₄+C₃+C₄. Because the capacitance C_{sw} of the variable capacitance capacitor C_{sw} is an analog quantity that continuously changes as described above, the frequency fsw of the alternating magnetic field sent out from the electromagnetic induction pen 2 in this case is an analog quantity that continuously changes according to the capacitance C_{sw}. Hence, the transmission of the pen pressure value P by the electromagnetic induction pen 2 can be said to be transmission using analog modulation (more specifically, frequency modulation).

On the other hand, the value of the combined capacitance Cc in a case where the electromagnetic induction pen 2 transmits the four-bit digital data changes discretely in 16 stages from C to C+C₁+C₄+C₃+C₄. The frequencies f₀ to f₁₅ of the alternating magnetic fields sent out from the electromagnetic induction pen 2 according to these values of the combined capacitance Cc represent digital values different from each other. Hence, the transmission of the digital data by the electromagnetic induction pen 2 can be said to be transmission using digital modulation (more specifically, frequency shift keying).

Here, a concrete value of the resonance frequency f_{R} of the resonance circuit is expressed by using an equation f_{R}=(2π(L×Cc)⁻¹). Hence, the larger the value of the combined capacitance Cc, the smaller the value of the resonance frequency f_{R}.

FIG. 27B is a diagram illustrating, on a straight line, the values of the resonance frequency f_{R}, which correspond to respective transmission values. As illustrated in the figure, the frequency fsw as the value of the resonance frequency f_{R} in a case where the electromagnetic induction pen 2 transmits the pen pressure value P changes within a range of frequencies lower than any of the frequencies f₀ to f₁₅. This is because the value C+C_{sw}+C₁+C₄+C₃+C₄ of the combined capacitance Cc in this case is a highest value among the plurality of values of the combined capacitance Cc illustrated in FIG. 27A irrespective of the value of the capacitance C_{sw}.

On the other hand, the value of the resonance frequency f_{R} in a case where the electromagnetic induction pen 2 transmits the digital data is one of the reference frequency f₀ and the frequencies f₁ to f₁₅ higher than the reference frequency. The reference frequency f₀ is lowest among the frequencies f₀ to fis because the value C+C₁+C₄+C₃+C₄ of the combined capacitance Cc, which corresponds to a transmission value 0000 is higher than the values of the combined capacitance Cc, which correspond to the other transmission values 0001 to 1111. Incidentally, a magnitude relation between the values of the combined capacitance Cc, which correspond to the transmission values 0001 to 1111 changes according to concrete values of the capacitances C₁ to C₄. However, when a capacitance ratio of C₁:C₂:C₃:C₄=8:4:2:1 is set, for example, a relation is obtained such that the combined capacitance Cc becomes lower when the transmission value becomes larger.

As described above, the position detection system 1 according to the present embodiment performs digital modulation by increasing the resonance frequency f_{R} from the reference frequency f₀, and performs analog modulation by continuously changing the resonance frequency f_{R} as a value lower than the reference frequency f₀. It is therefore possible to suppress amounts of change in frequency from the reference frequency f₀ as compared with a case where both digital modulation and analog modulation are performed on a same positive or negative side as viewed from the reference frequency f₀. Hence, the position detection system 1 according to the present embodiment can narrow a range of a discrete Fourier transform (or a fast Fourier transform) of the induced current Rx, which is performed by the sensor controller 31.

Preferred embodiments of the present disclosure have been described above. However, the present disclosure is not at all limited to such embodiments, but the present disclosure can, needless to say, be carried out in various modes without departing from the spirit of the present disclosure.

For example, the method of transmitting the digital data according to the fifth embodiment can be applied also to the transmission of the digital data by the electromagnetic induction pen 2 according to the second embodiment or the fourth embodiment. That is, the electromagnetic induction pen 2 according to the second embodiment or the fourth embodiment may transmit four bits of digital data at the same time by frequency shift keying implemented by on-off control of the switch elements 65 to 68 instead of transmitting one bit of digital data by amplitude shift keying implemented by on-off control of the switch element 25. This makes it possible to realize the transmission of more digital data or the transmission of a predetermined number of bits of digital data in a shorter time or both thereof.

### DESCRIPTION OF REFERENCE SYMBOLS

1: Position detection system
2: Electromagnetic induction pen
3: Position detecting device
20 Core body
21: Pressure sensor
22a, 22b: Side switch
23 Processing circuit
24, 25: Switch element
30: Switch unit
31 Sensor controller
32 Host processor
40: Power supply circuit
41: Detecting circuit
41a: Half-wave voltage doubler rectifier circuit
41b, 41d: Voltage dividing circuit
41c: Smoothing circuit
41e: Operational amplifier
41f, 42a, 44a: Resistive element
41g, 41i: Inverting buffer circuit
41h: RC low-pass filter
42: Wait detecting circuit
42b, 44b: Schottky barrier diode
42c, 44c: Capacitor
42d, 44d: Schmitt trigger circuit
43: Toggle circuit
43a, 51, 53, 55: Flip-flop circuit
44: Long burst detecting circuit
45: Timing generating circuit
46a to 46d, 65 to 68: Switch element
47, 57a to 57d: AND circuit
50: Adder
52, 54, 56: Logic circuit
58: OR circuit
AM: Alternating magnetic field
C, C₁ to C₄: Capacitor
C_{sw}: Variable capacitance capacitor
L: Coil
LC, LCy, LCx: Loop coil
PS: Alternating magnetic field
PSM: Modulated alternating magnetic field
PSS: Reference alternating magnetic field
R1: First resonance circuit
R2: Second resonance circuit

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An electromagnetic induction pen comprising:
a first resonance circuit including an inductance element and a capacitance element;
a changing element connected to the first resonance circuit, wherein the changing element, in operation, changes a resonance frequency of a second resonance circuit including the changing element and the first resonance circuit based on a behavior of a user; and
a toggle circuit that, in operation, switches between sending out a reference alternating magnetic field by using the first resonance circuit and sending out a modulated alternating magnetic field by using the second resonance circuit.

2. The electromagnetic induction pen according to claim 1, wherein
a sending-out stop period in which neither the reference alternating magnetic field nor the modulated alternating magnetic field is sent out is provided between sending out of the reference alternating magnetic field and sending out of the modulated alternating magnetic field.

3. The electromagnetic induction pen according to claim 1, wherein
the toggle circuit, in operation, switches between sending out of the reference alternating magnetic field and sending out of the modulated alternating magnetic field in response to passage of a predetermined time or more since an alternating magnetic field ceases to be received from a position detecting device.

4. The electromagnetic induction pen according to claim 1, wherein
the toggle circuit, in operation, repeats sending out of the reference alternating magnetic field and sending out of the modulated alternating magnetic field in a predetermined pattern after a predetermined timing detected within the electromagnetic induction pen.

5. The electromagnetic induction pen according to claim 4, wherein
the predetermined timing is given by an alternating magnetic field from a position detecting device.

6. The electromagnetic induction pen according to claim 5, wherein
an order of sending out the reference alternating magnetic field and the modulated alternating magnetic field is reset in response to continuously receiving the alternating magnetic field from the position detecting device over a predetermined time.

7. An integrated circuit for a position detecting device, comprising:
a processor; and
a memory storing instructions that, when executed by the processor, cause the integrated circuit to:
receive a received alternating magnetic field that is a reference alternating magnetic field generated by using a first resonance circuit or a modulated alternating magnetic field generated by using a second resonance circuit from an electromagnetic induction pen including the first resonance circuit, the second resonance circuit, and a changing element, wherein the first resonance circuit includes an inductance element and a capacitance element, wherein the changing element is connected to the first resonance circuit, wherein the changing element, in operation, changes a resonance frequency of the second resonance circuit based on a behavior of a user, and wherein the second resonance circuit includes the changing element and the first resonance circuit;
determine whether the received alternating magnetic field is the reference alternating magnetic field or the modulated alternating magnetic field; and
output a digital value corresponding to an analog quantity indicated by the modulated alternating magnetic field in response to the received alternating magnetic field being determined to be the reference alternating magnetic field.

8. The integrated circuit according to claim 7, wherein
two alternating magnetic fields are received before the integrated circuit determines whether the received alternating magnetic field is the reference alternating magnetic field or the modulated alternating magnetic field, and
the integrated circuit determines whether the received alternating magnetic field is the reference alternating magnetic field or the modulated alternating magnetic field based on a phase,
frequency, or amplitude of each of the two alternating magnetic fields.

9. The integrated circuit according to claim 7, wherein
the integrated circuit, in operation, determines that the received alternating magnetic field is the reference alternating magnetic field when a phase, frequency, or amplitude of the received alternating magnetic field satisfies a predetermined condition.

10. The integrated circuit according to claim 7, wherein
the electromagnetic induction pen, in operation, repeats sending out of the reference alternating magnetic field and sending out of the modulated alternating magnetic field in a predetermined order, and
the integrated circuit, in operation, performs reception of the reference alternating magnetic field and reception of the modulated alternating magnetic field in the predetermined order after determining that the received alternating magnetic field is the reference alternating magnetic field.

11. A position detecting device comprising:
a processor; and
a memory storing instructions that, when executed by the processor, cause the position detecting device to:
receive each of a reference alternating magnetic field generated by using a first resonance circuit and a modulated alternating magnetic field generated by using a second resonance circuit from an electromagnetic induction pen including the first resonance circuit, the second resonance circuit, and a changing element, wherein the first resonance circuit includes an inductance element and a capacitance element, wherein the changing element is connected to the first resonance circuit, wherein the changing element, in operation, changes a resonance frequency of the second resonance circuit based on a behavior of a user, wherein the second resonance circuit includes the changing element and the first resonance circuit;
obtain a first output based on the reference alternating magnetic field;
obtain a second output based on the modulated alternating magnetic field;
obtain a third output by adding or subtracting a predetermined offset amount to or from a difference between the first output and the second output; and
convert the third output into a digital value by a predetermined conversion rule.

12. The position detecting device according to claim 11, wherein
the predetermined offset amount is determined based on the difference between the first output and the second output in a state in which the behavior of the user is not performed.

13. The position detecting device according to claim 11, wherein
the predetermined conversion rule sets the digital value as a value indicating that the behavior of the user is not performed when the third output is smaller than the value indicating that the behavior of the user is not performed.

14. The position detecting device according to claim 11, wherein
according to the predetermined conversion rule, an amount of change in the digital value with respect to a change in an amount of the behavior of the user becomes larger when the amount of the behavior of the user becomes larger.
